(19) United States
(12) Patent Application Publication
(10) Pub. No.: US 2006/0057565 A1
(43) Pub. Date: Mar. 16, 2006

(54) Combinatorial fluorescence energy transfer tags and uses thereof

(76) Inventors: Jingyue Ju, Englewood Cliffs, NJ (US); Zengmin Li, New York, NY (US); Anthony Tong, New York, NY (US); James J Russo, New York, NY (US)

Correspondence Address: John P White;Cooper & Dunham, 1185 Avenue of the Americas, New York, NY, 10036, US

(21) Appl. No.: 10/380,256

(22) PCT Filed: Sep. 11, 2001
(86) PCT No.: PCT/US01/28967

§ 371 Date: Nov. 10, 2003

Related U.S. Application Data
(63) Continuation-in-part of application No. 09/658,077, filed on Sep. 11, 2000, now Pat. No. 6,627,748.

(51) Int. Cl. C40B 40/08; C40B 40/10

(52) U.S. Cl. 435/6; 435/7.1

(57) ABSTRACT

This invention provides a combinatorial fluorescence energy transfer tag which comprises a plurality of fluorescent molecules, comprising one or more energy transfer donor and one or more energy transfer acceptor, linked through a molecular scaffold wherein the fluorescent molecules are separated along the scaffold to produce a unique fluorescene emission signature. The invention further provides for the use of said tags in multi-component analyses, including multiplex biological analyses.

This application claims priority of Provisional Application No. 60/309,156, filed Jul. 31, 2001 and is a continuation in part of U.S. Ser. No. 09/658,077, filed Sep. 11, 2000, the contents of both of which are hereby incorporated by reference into the subject application.

Throughout this application, various publications are referenced in parentheses by author and year. Full citations for these references may be found at the end of the specification immediately preceding the claims. The disclosures of these publications in their entireties are hereby incorporated by reference into this application to more fully describe the state of the art to which this invention pertains.

### BACKGROUND OF THE INVENTION

The need to study many biological targets simultaneously drives the development of multiplex fluorescent tags. However, due to the limits of the spectral region, and therefore the availability of appropriate detectors, the number of available fluorescent dyes that have distinguishable emission spectra is limited to about ten. To overcome this limitation, a combinatorial fluorescent labeling approach for multi-color fluorescence in situ hybridization (M-FISH) has been developed and is now widely used in the field of cytogenetics (Speicher et al., 1996; Schrock et al., 1996). This approach mixes from two to seven individual fluorescent dyes that have unique emissions, and uses the fluorescence emission pattern to identify the different targets. The unique fluorescence emission pattern is achieved by mathematically combining the different dyes. This development has made possible advances in chromosome analyses. However, the procedure requires physically mixing the individual dyes in a quantitative manner to develop “unique” probe labels. This requirement, coupled with the potential interactions of the dyes, complicates the fluorescence emission patterns. Therefore, the major application of the technique is limited to methods that involve hybridization. Multiple lasers and detectors are also required for the imaging. A reagent kit that can be used to covalently label a wide range of biomolecules is difficult to construct with this approach. Thus, there is an urgent need for a large set of fluorescent tags that can be used for multiple component analyses in biomedical and other fields. Previously, the principle of fluorescent energy transfer (ET) was used to enhance fluorescence emission for the successful development of four ET tags for deoxyribonucleic acid (DNA) sequencing which are widely used in the Human Genome Project (Ju et al. 1995, 1996). Tags containing fluorophores in energy transfer relationships have been disclosed in U.S. Pat. 6,028,190.

### SUMMARY OF THE INVENTION

This invention provides a composition of matter comprising multiple fluorophores, each of which is bound to a molecular scaffold at a separate predetermined position on the scaffold, such separate predetermined positions being selected so as to permit fluorescence energy transfer between one such fluorophore and another such fluorophore, wherein the one such fluorophore and the another such fluorophore are characterized by the maximum emission wavelength of one being greater than the minimum excitation wavelength of the other.

This invention further provides the instant composition of matter comprising two fluorophores, each of which is bound to a molecular scaffold, at a separate predetermined position on the scaffold, such separate positions being selected so as to permit fluorescence energy transfer between such fluorophores, and such fluorophores being characterized by the maximum emission wavelength of one of the fluorophores being greater than the minimum excitation wavelength of the other fluorophore.

This invention further provides the instant composition of matter comprising three fluorophores each of which is bound to a molecular scaffold at a separate predetermined position on the scaffold, such separate predetermined positions being selected so as to permit fluorescence energy transfer among such fluorophores and such fluorophores being characterized by the maximum emission wavelength of one such fluorophore being greater than the minimum excitation wavelength of the second such fluorophore and the maximum emission wavelength of such second fluorophore being greater than the minimum excitation wavelength of the third such fluorophore.

This invention further provides the instant composition of matter, wherein each fluorophore is covalently bound to the molecular scaffold.

This invention further provides the instant composition of matter, wherein the efficiency of the fluorescence energy transfer is less than 20%.

This invention further provides the instant composition of matter, wherein the molecular scaffold is rigid.

This invention further provides the instant composition of matter, wherein the molecular scaffold is polymeric.

This invention further provides the instant composition of matter, wherein the molecular scaffold comprises a nucleic acid.

This invention further provides the instant composition of matter, wherein the molecular scaffold comprises a peptide.

This invention further provides the instant composition of matter, wherein the molecular scaffold comprises a polyphosphate.

This invention further provides the instant composition of matter, wherein at least one fluorophore is a fluorescent dye.

This invention further provides the instant composition of matter, wherein the fluorescent dye is 6-carboxyfluorescein.

This invention further provides the instant composition of matter, wherein the fluorescent dye is N,N,N′,N′-tetramethyl-6-carboxyrhodamine.

This invention further provides the instant composition of matter, wherein the fluorescent dye is cyanine-5 monofunctional dye.

This invention further provides the instant composition of matter, wherein at least one fluorophore is a luminescent molecule.

This invention further provides the instant composition of matter, wherein at least one fluorophore is a quantum dot.

This invention also provides a composition of matter having the structure: 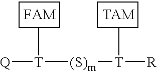
wherein S represents a 1′,2′-dideoxyribose phosphate moiety, m is an integer greater than 1 and less than 100, each T represents a thymidine derivative, FAM represents 6-carboxyfluorescein derivative, TAM represents N,N,N′,N′-tetramethyl-6-carboxyrhodamine derivative, each solid line represents a covalent bond, R represents either a hydroxy or phosphate terminus and Q represents either a hydroxy or phosphate terminus, with the proviso that R and Q are different.

This invention further provides the instant composition of matter, wherein m is 4.

This invention further provides the instant composition of matter, wherein m is 6.

This invention further provides the instant composition of matter, wherein m is 9.

This invention further provides the instant composition of matter, wherein m is 13.

This invention also provides a composition of matter having the structure: 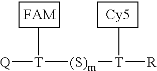
wherein S represents a 1′,2′-dideoxyribose phosphate moiety, m is an integer greater than 1 and less than 100, T represents a thymidine derivative, FAM represents a 6-carboxyfluorescein derivative, Cy5 represents a cyanine-5 monofunctional dye derivative, each solid line represents a covalent bond, R represents either a hydroxy or phosphate terminus and Q represents either a hydroxy or phosphate terminus, with the proviso that R and Q are different.

This invention further provides the instant composition of matter, wherein m is 4.

This invention further provides the instant composition of matter, wherein m is 5.

This invention further provides the instant composition of matter, wherein m is 7.

This invention further provides the instant composition of matter, wherein m is 10.

This invention further provides the instant composition of matter, wherein m is 13.

This invention also provides a composition of matter comprising the structure shown below: 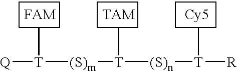
wherein S represents a 1′,2′-dideoxyribose phosphate moiety, m is an integer greater than 1 and less than 100, n is an integer greater than 1 and less than 100, T represents a thymidine derivative, FAM represents a 6-carboxyfluorescein derivative, Cy5 represents a cyanine-5 monofunctional dye derivative, TAM represents a N,N,N′,N′-tetramethyl-6-carboxyrhodamine derivative, each solid line represents a covalent bond, R represents either a hydroxy or phosphate terminus and Q represents either a hydroxy or phosphate terminus, with the proviso that R and Q are different.

This invention further provides the instant composition of matter, wherein m is 3, and n is 7.

This invention further provides the instant composition of matter, wherein m is 4, and n is 6.

This invention further provides the instant composition of matter, wherein m is 5, and n is 5

This invention further provides the instant composition of matter, wherein m is 6, and n is 6.

This invention further provides the instant composition of matter, wherein m is 7, and n is 7.

This invention also provides a composition of matter comprising the structure shown below: 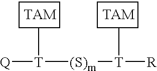
wherein S represents a 1′,2′-dideoxyribose phosphate moiety, m represents an integer greater than 1 and less than 100, T represents a thymidine derivative, and TAM represents a N,N,N′,N′-tetramethyl-6-carboxyrhodamine derivative, each solid line represents a covalent bond, R represents either a hydroxy or phosphate terminus and Q represents either a hydroxy or phosphate terminus, with the proviso that R and Q are different.

This invention further provides the instant composition of matter, wherein m is 4.

This invention also provides a nucleic acid labeled with any of the instant compositions.

This invention provides any of the instant compositions, wherein the nucleic acid is DNA.

This invention provides any of the instant compositions, wherein the nucleic acid is RNA.

This invention provides any of the instant compositions, wherein the nucleic acid is DNA/RNA.

This invention also provides a method of determining whether a preselected nucleotide residue is present at a predetermined position within a nucleic acid comprising the steps of:
(a) contacting the nucleic acid, under hybridizing and DNA ligation-permitting conditions, with (i) a DNA ligase, (ii) a first oligonucleotide having affixed thereto a composition of matter of claim 1 wherein the first oligonucleotide hybridizes with nucleotides immediately adjacent one side of the predetermined position and (iii) a second oligonucleotide which hybridizes with the nucleotides immediately adjacent the other side of the predetermined position, wherein the hydroxy-terminal residue of the is oligonucleotide which hybridizes to the nucleotide located 3′ of the predetermined position is a nucleotide which is complementary to the preselected nucleotide residue; and
(b) detecting the presence of a ligation product comprising both the first and the second oligonucleotides, the presence of such a ligation product indicating the presence of the preselected nucleotide residue at the predetermined position.

This invention further provides a method of determining whether at various predetermined positions within a nucleic acid, a preselected nucleotide residue is present at such position, wherein the preselected nucleotide residue may vary at different predetermined positions which comprises determining whether each preselected nucleotide is present each predetermined position according to the instant method.

This invention provides the instant method, wherein the presence of a plurality of given nucleotide residues is determined simultaneously.

This invention further provides the instant method, wherein the DNA ligase is Taq DNA ligase.

This invention further provides the instant method, wherein the second oligonucleotide has an isolation-permitting moiety affixed thereto, and wherein the method further comprises the steps of isolating the moiety-containing molecules resulting from step (a) and determining the presence therein of ligated first and second oligonucleotides.

This invention further provides the instant method, wherein the composition of matter affixed to the first oligonucleotide has a predetermined emission spectrum, and wherein the observation of this emission spectrum is employed to determine the presence of ligated first and second oligonucleotides in step (b).

This invention also provides a method of determining whether a preselected nucleotide residue is present at a predetermined position within a nucleic acid comprising the steps of:
(a) contacting the nucleic acid, under hybridizing and DNA polymerization-permitting conditions, with (i) a DNA polymerase, (ii) an oligonucleotide (1) having affixed thereto a composition of matter of claim 1, and (2) having a hydroxyl 3′ terminus thereof, wherein the oligonucleotide hybridizes with the 3′ region of the nucleic acid molecule flanking the predetermined position, and (iii) a dideoxynucleotide labeled with an isolation-permitting moiety, wherein the labeled dideoxynucleotide is complementary to the given nucleotide residue,
with the proviso that upon hybridization of the oligonucleotide with the nucleic acid in the presence of DNA polymerase and the preselected nucleotide residue, the oligonucleotide and dideoxynucleotide are juxtaposed so as to permit their covalent linkage by the DNA polymerase;
(b) detecting the presence of a polymerization product comprising both the oligonucleotide and the dideoxynucleotide, the presence of such a polymerization product indicating the presence of the preselected nucleotide residue at the predetermined position.

This invention further provides a method of determining whether at various predetermined positions within a nucleic acid, a preselected nucleotide residue is present at such position, wherein the preselected nucleotide residue may vary at different predetermined positions which comprises determining whether each preselected nucleotide is present each predetermined position according to the instant method.

This invention further provides the instant method, wherein the DNA polymerase is thermo sequenase.

This invention further provides the instant method, wherein the dideoxynucleotide is selected from the group consisting of dideoxyadenosine triphosphate, dideoxycytidine triphosphate, dideoxyguanosine triphosphate, dideoxythymidine triphosphate, and dideoxyuridine triphosphate.

This invention further provides the instant method, wherein the composition of matter affixed to the oligonucleotide has a predetermined emission spectrum, and wherein the observation of this emission spectrum is employed to determine the presence of polymerization product in step (b).

This invention further provides the instant methods, wherein observing the predetermined emission spectrum is performed using radiation having a wavelength of between 200 and 1000 nm.

This invention further provides the instant methods, wherein the radiation has a wavelength of 488 nm.

This invention further provides the instant methods, wherein observing the predetermined emission spectrum is performed using radiation having a bandwidth of between 1 and 50 nm.

This invention further provides the instant methods, wherein the radiation bandwidth is 1 nm.

This invention further provides the instant methods, wherein the isolation-permitting moiety comprises biotin, streptavidin, phenylboronic acid, salicylhydroxamic acid, an antibody or an antigen.

This invention further provides the instant methods, wherein the isolation-permitting moiety is attached to the oligonucleotide via a linker molecule.

This invention further provides the instant methods, wherein the isolation-permitting moiety is attached to the dideoxynucleotide via a linker molecule.

This invention further provides the instant methods, wherein the linker molecule is chemically cleavable.

This invention further provides the instant methods, wherein the linker molecule is photocleavable.

This invention further provides the instant methods, wherein the linker molecule has the structure:

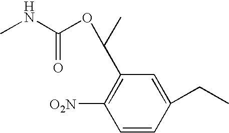

### BRIEF DESCRIPTION OF THE FIGURES

FIG. 1A-B: (A) Schematic of a multi-chromophore assembly connected to a linker. In general, 1 to n chromophores can be attached to the assembly with the chromophores separated by spacers as shown. Chromophores can be, but not limited to, fluorescent dyes, quantum dots or luminescent molecules such as terbium chelate. A variety of spacers such as nucleotides, peptides, a polymer linker formed by 1′, 2′-dideoxyribose phosphates or other chemical moieties can be used. The assembly label shown here is connected to a linker which can be designed as nucleic acids, proteins or cells, etc for multiplex biological assays. (B) The synthesis of F-4-T-6-C. The numbers in F-4-T-6-C refer to the number of spacing nucleotides in the scaffold between dyes F and T, and T and C. F=Fam; T=Tam; C=Cyanine 5 monofunctional dye.

FIG. 2A-D: Spectroscopic data for tags F-4-T-6-C and F-7-T-3-C.
(A) Two tags with different fluorescent signatures have been constructed by varying the spacing between the three dyes F, T, and C.
(B) Ultraviolet/visible (UV/vis) absorption spectrum of dye F-4-T-6-C.
(C) Fluorescence emission spectra of dye F-4-T-6-C.
(D) Fluorescence emission spectra of dye F-7-T-3-C. F=Fam; T=Tam; C=Cy5.

FIG. 3A-B: Schematic labeling approach to construct CFET-primers and CFET-dUTPs. The spacer between dyes is 1′,2′-dideoxyribose phosphate (S) in (A) and proline (P) in (B). “m” and “n” refer to the number of molecules in the spacer. dUTP=deoxyuridine triphosphate.

FIG. 4: The synthesis of CFET-dUTP. The CFET tag comprises three different fluorescent dyes: Fam, Tam and Cy5.

FIG. 5: Structures of Aminoallyl (AA)-dUTP, Fam-proline, and N-Hydroxy succinimide (NHS) esters of TAM and Cy5.

FIG. 6: Synthetic schemes to prepare Fam-proline, Azido-proline and Cy5-phosphine. TMSCI=trimethylsilyl chloride.

FIG. 7: The eight unique fluorescence signatures of CFET tags generated in a three-color CAE system. FAM channel (520±20 nm, dotted line), TAM channel (585±20 nm, solid thin line), Cy5 channel (670±20 nm, solid thick line). The digital ratio denoting the fluorescence signature for each CFET tag from the three channels [dotted:thin:thick] is shown in the brackets. The fluorescence signatures in the electropherogram were obtained by excitation at 488 nm and electrokinetic injection of the eight CFET-labeled oligonucleotides into the three-color CAE system.

FIG. 8A-B: Schematic of using ligase chain reaction for determining the genotype at a locus containing a possible single-base mutation.
(A) Primer pairs are generated surrounding a base that can be mutated. The wild-type primer is labeled with one CFET tag (Tag 1) and the mutation-specific primer with another CFET tag (Tag 2).
(B) Subsequent gel electrophoresis allows separation of ligated primer pairs and unincorporated primers. Different bands appear on the gel depending on whether the template is wild-type or mutated.

FIG. 9: Schematic of expected results from screening four potential mutation sites of Rb1 gene using eight unique CFET Tags and the ligase chain reaction assay. Only ligation products are shown on the gels.

FIG. 10: Schematic of chromosomal studies to detect macrodeletions and amplifications.

FIG. 11: This figure schematically shows the procedure for multiplex SNP detection through the ligation of hybridized CFET-labeled and biotinylated oligonucleotides. Taq DNA ligase seals the nick between the two hybridized oligonucleotides if the nucleotides at the ligating junction are correctly base-paired to the template (A to T; C to G). CFET-labeled, biotinylated ligation products are then isolated using streptavidin-coated magnetic beads. After washing and releasing from the magnetic beads, the ligation products are electrokinetically injected into a three-color CAE system. Each CFET-labeled ligation product, which identifies a unique SNP, is unambiguously detected due to its distinct mobility and fluorescence signature in the CAE electropherogram.

FIG. 12A-B: Electropherogram of CFET-labeled ligation products for SNPs identification on exon 20 of the RB1. (A) Detection of six nucleotide variations from synthetic DNA templates. FAM (T) and F-10-Cy5 (T) peaks are obtained from two different locations of the same template. F-9-T (C) and F-13-T (T) peaks indicate mutations from the same locus of a DNA template, while F-4-T-6-Cy5 (A) and F-7-T-7-Cy5 (C) peaks identify mutations from the same locus of another DNA template. (B) Detection of three homozygous genotypes (T, C and A) from a PCR product of RB1.

FIG. 13: This figure is a schematic of single base primer extension for multiplex SNP detection by using dye-labeled primers and biotinylated dideoxynucleoside triphosphates (ddNTP-Biotin). DNA template containing polymorphic sites is incubated with a dye-labeled primer, hybridizing the template adjacent to the polymorphic site, ddNTP-Biotin and thermo sequenase. At the end of reaction and purification the primer extension products are analyzed for fluorescence signatures.

FIG. 14: Three unique fluorescence signatures generated from dye-labeled extension products. FAM channel (light) and TAM channel (Dark). The fluorescence signatures in the electropherograms were obtained by excitation at 488nm and the single base extension of the dye-labeled primers. The digital ratio denoting the fluorescence signature for each from the two detection channels is shown in parentheses.

FIG. 15A-C: The electropherograms of CFET-labeled primer extension products for multiplex SNPs identification on the mimic of exon 20 of the RB1. FAM channel (Light line) and TAM channel (Dark line). (A): Detection of two individual homozygous genotypes from a wild type template. FAM (T) and F-9-T (C) peaks were obtained from two different loci on the template. (B): Similar to (A) except a mutated template was used. (C): Simultaneous detection of three nucleotide variations. FAM (T) peak was obtained from a locus of the template where a homozygous genotype was found. F-9-T (C) and F-13-T (T) peaks indicate the mutation R661W (heterozygote) from the same locus of a DNA template.

FIG. 16: Schematic of a high throughput channel based, moiety-based purification system. Sample solutions can be pushed back and forth between the two plates through glass capillaries and the coated channels in the chip, the channels being coated with an appropriate chemical to bind the moiety tag on the samples, e.g. streptavidin coating in the case of biotinylated oligonucleotides. Where the moieties are attached by cleavable linkers, e.g. photocleavable linkers, the whole chip can be irradiated to cleave the samples after immobilization.

### DETAILED DESCRIPTION OF THE INVENTION

Definitions

The following definitions are offered as an aid to understanding the invention:
CAE—Capillary Array Electrophoresis
CFET—Combinatorial fluorescence energy transfer;
Cy 5—Cyanine 5 monofunctional dye;
ddNTP—Dideoxynucleotide trisphosphate;
FAM—6-carboxyfluorescein;
nm—nanometer
RB1—Retinoblastoma gene;
SNP—Single nucleotide polymorphism;
TAM—N,N,N′,N′-tetramethyl-6-carboxy rhodamine.

As used herein, and unless stated otherwise, each of the following terms shall have the definition set forth below.

“Chemically cleavable” shall mean cleavable by any chemical means including but not limited to pH and temperature.

“DNA/RNA” shall mean a nucleic acid molecule comprising both deoxyribonucleotides and ribonucleotides.

“Emission spectrum” shall mean the amplitude and frequency of energy emitted from a composition of matter as a result of exciting radiation thereon.

“Flexible”, when used to describe a molecular scaffold, shall mean that the distance between the centers of any pair of fluorophores covalently bound to the scaffold varies by more than 50%.

“Fluorescence energy transfer” shall mean the transfer of energy between two fluorophores via a dipole-dipole interaction.

“Fluorescent dye” shall mean an organic dye molecule capable of emitting fluorescent energy of wavelength between 200 and 1000 nm when excited by an energy of shorter wavelength wherein the emitted energy results from a singlet to singlet transition. Examples are 6-carboxyfluorescein, N,N,N′,N′-tetramethyl-6-carboxyrhodamine, and cyanine-5 monofunctional dye.

“Fluorophore” shall mean a molecule, such as a fluorescent dye, quantum dot or luminescent molecule, capable of emitting energy of wavelength between 400 and 1000 nm when excited by an energy of shorter wavelength than the corresponding emission wavelength. Examples of fluorophores include 6-carboxyfluorescein, N,N,N′,N′-tetramethyl-6-carboxy rhodamine, cyanine-5 monofunctional dye, zinc sulfide-capped cadmium selenide quantum dots, and lanthanide chelates.

“Hybridize” shall mean the annealing of one single-stranded nucleic acid molecule to another single stranded nucleic acid molecule based on sequence complementarity. The propensity for hybridization between nucleic acids depends on the temperature and ionic strength of their milieu, the length of the nucleic acids and the degree of complementarity. The effect of these parameters on hybridization is well known in the art (see Sambrook, 1989).

“Isolation-permitting moieties” shall include without limitation biotin or streptavidin which bind to one another, antibodies or antigens which bind to one another, phenylboronic acid or salicylhydroxamic acid which bind to one another.

“Ligation-permitting conditions” include without limitation conditions of temperature, ionic strength, ionic composition, molecular composition, orientation and viscosity that allow one oligonucleotide to be joined enzymatically to another via a phosphodiester bond.

“Ligation” shall mean the enzymatic covalent joining of a nucleic acid with either another nucleic acid or a single nucleotide.

“Linker molecule” shall mean a chemical group used to covalently join two other molecules. An example of a linker molecule is the structure given below:

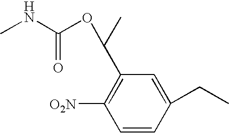

“Luminescent molecule” shall mean a molecule capable of emitting energy of wavelength between 200 and 1000 nm when excited by energy of shorter wavelength than the corresponding emission wavelength, wherein the emitted energy does not result from a singlet to singlet transition. Examples of luminescent molecules include europium polycarboxylate chelate and terbium chelates.

“Molecular scaffold” shall mean a molecular structure to which two or more fluorophores can be, and/or are, covalently bound at discrete loci thereon. Ideally, a molecular scaffold is polymeric, comprising monomeric units to which fluorophores can be bound. The monomeric units which make up such polymeric scaffold can, but need not be; identical. Examples of such monomeric units include 1′,2′-dideoxyribose phosphate and thymidine.

“Nucleic acid molecule” shall mean any nucleic acid molecule, including, without limitation, DNA, RNA and hybrids thereof. The nucleic acid bases that form nucleic acid molecules can be the bases A, C, G, T and U, as well as derivatives thereof. Derivatives of these bases are well known in the art, and are exemplified in PCR Systems, Reagents and Consumables (Perkin Elmer Catalogue 1996-1997, Roche Molecular Systems, Inc., Branchburg, N.J., USA).

“Oligonucleotide” shall mean a nucleic acid comprising two or more nucleotides.

“Photocleavable” shall mean cleavable by electromagnetic energy of between 200 and 1000 nm wavelength.

“Polymeric” shall describe a molecule composed of more than two monomeric units.

“Quantum dot” shall mean a nanometer-sized composition of matter comprising a semi-conductor or metal, wherein such composition is capable of luminescence. Examples of quantum dots include zinc-sulfide-capped cadmium selenide quantum dots.

“Rigid”, when used to describe a molecular scaffold, shall mean that the distance between the centers of any pair of fluorophores covalently bound to the scaffold does not vary more than 50%.

### EMBODIMENTS OF THE INVENTION

This invention provides a composition of matter comprising multiple fluorophores, each of which is bound to a molecular scaffold at a separate predetermined position on the scaffold, such separate predetermined positions being selected so as to permit fluorescence energy transfer between one such fluorophore and another such fluorophore, wherein the one such fluorophore and the another such fluorophore are characterized by the maximum emission wavelength of one being greater than the minimum excitation wavelength of the other.

This invention further provides the instant composition of matter comprising two fluorophores, each of which is bound to a molecular scaffold, at a separate predetermined position on the scaffold, such separate positions being selected so as to permit fluorescence energy transfer between such fluorophores, and such fluorophores being characterized by the maximum emission wavelength of one of the fluorophores being greater than the minimum excitation wavelength of the other fluorophore.

This invention further provides the instant composition of matter comprising three fluorophores each of which is bound to a molecular scaffold at a separate predetermined position on the scaffold, such separate predetermined positions being selected so as to permit fluorescence energy transfer among such fluorophores and such fluorophores being characterized by the maximum emission wavelength of one such fluorophore being greater than the minimum excitation wavelength of the second such fluorophore and the maximum emission wavelength of such second fluorophore being greater than the minimum excitation wavelength of the third such fluorophore.

In one embodiment each fluorophore is covalently bound to the molecular scaffold.

In one embodiment the efficiency of the fluorescence energy transfer is less than 20%.

In one embodiment the molecular scaffold is rigid.

In one embodiment the molecular scaffold is polymeric.

In one embodiment the molecular scaffold comprises a nucleic acid.

In one embodiment the molecular scaffold comprises a peptide.

In one embodiment the molecular scaffold comprises a polyphosphate.

In one embodiment at least one fluorophore is a fluorescent dye.

In one embodiment the fluorescent dye is 6-carboxyfluorescein.

In one embodiment the fluorescent dye is N,N,N′,N′-tetramethyl-6-carboxyrhodamine.

In one embodiment the fluorescent dye is cyanine-5 monofunctional dye.

In one embodiment at least one fluorophore is a luminescent molecule.

In one embodiment at least one fluorophore is a quantum dot.

This invention also provides a composition of matter having the structure: 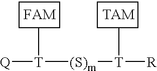
wherein S represents a 1′,2′-dideoxyribose phosphate moiety, m is an integer greater than 1 and less than 100, each T represents a thymidine derivative, FAM represents 6-carboxyfluorescein derivative, TAM represents N,N,N′,N′-tetramethyl-6-carboxyrhodamine derivative, each solid line represents a covalent bond, R represents either a hydroxy or phosphate terminus and Q represents either a hydroxy or phosphate terminus, with the proviso that R and Q are different.

In one embodiment m is 4. In one embodiment m is 6. In one embodiment m is 9. In one embodiment m is 13.

This invention also provides a composition of matter having the structure: 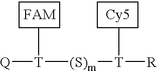
wherein S represents a 1′,2′-dideoxyribose phosphate moiety, m is an integer greater than 1 and less than 100, T represents a thymidine derivative, FAM represents a 6-carboxyfluorescein derivative, Cy5 represents a cyanine-5 monofunctional dye derivative, each solid line represents a covalent bond, R represents either a hydroxy or phosphate terminus and Q represents either a hydroxy or phosphate terminus, with the proviso that R and Q are different.

In one embodiment m is 4. In one embodiment m is 5. In one embodiment n m is 7. In one embodiment m is 10. In one embodiment m is 13.

This invention also provides a composition of matter comprising the structure shown below: 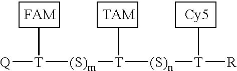
wherein S represents a 1′,2′-dideoxyribose phosphate moiety, m is an integer greater than 1 and less than 100, n is an integer greater than 1 and less than 100, T represents a thymidine derivative, FAM represents a 6-carboxyfluorescein-derivative, Cy5 represents a cyanine-5 monofunctional dye derivative, TAM represents a N,N,N′,N′-tetramethyl-6-carboxyrhodamine derivative, each solid line represents a covalent bond, R represents either a hydroxy or phosphate terminus and Q represents either a hydroxy or phosphate terminus, with the proviso that R and Q are different.

In one embodiment m is 3, and n is 7. In one embodiment, wherein m is 4, and n is 6. In one embodiment m is 5, and n is 5. In one embodiment m is 6, and n is 6. In one embodiment m is 7, and n is 7.

This invention also provides a composition of matter comprising the structure shown below: 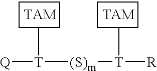
wherein S represents a 1′,2′-dideoxyribose phosphate moiety, m represents an integer greater than 1 and less than 100, T represents a thymidine derivative, and TAM represents a N,N,N′,N′-tetramethyl-6-carboxyrhodamine derivative, each solid line represents a covalent bond, R represents either a hydroxy or phosphate terminus and Q represents either a hydroxy or phosphate terminus, with the proviso that R and Q are different.

In one embodiment m is 4.

This invention also provides a nucleic acid labeled with any of the instant compositions.

In one embodiment the nucleic acid is DNA.

In one embodiment the nucleic acid is RNA.

In one embodiment the nucleic acid is DNA/RNA.

This invention also provides a method of determining whether a preselected nucleotide residue is present at a predetermined position within a nucleic acid comprising the steps of:
(a) contacting the nucleic acid, under hybridizing and DNA ligation-permitting conditions, with (i) a DNA ligase, (ii) a first oligonucleotide having affixed thereto a composition of matter of claim 1 wherein the first oligonucleotide hybridizes with nucleotides immediately adjacent one side of the predetermined position and (iii) a second oligonucleotide which hybridizes with the nucleotides immediately adjacent the other side of the predetermined position, wherein the hydroxy-terminal residue of the oligonucleotide which hybridizes to the nucleotide located 3′ of the predetermined position is a nucleotide which is complementary to the preselected nucleotide residue; and
(b) detecting the presence of a ligation product comprising both the first and the second oligonucleotides, the presence of such a ligation product indicating the presence of the preselected nucleotide residue at the predetermined position.

This invention further provides a method of determining whether at various predetermined positions within a nucleic acid, a preselected nucleotide residue is present at such position, wherein the preselected nucleotide residue may vary at different predetermined positions which comprises determining whether each preselected nucleotide is present each predetermined position according to the instant method.

In one embodiment the presence of a plurality of given nucleotide residues is determined simultaneously.

is In one embodiment the DNA ligase is Taq DNA ligase.

This invention further provides the instant method, wherein the second oligonucleotide has an isolation-permitting moiety affixed thereto, and wherein the method further comprises the steps of isolating the moiety-containing molecules resulting from step (a) and determining the presence therein of ligated first and second oligonucleotides.

This invention further provides the instant method, wherein the composition of matter affixed to the first oligonucleotide has a predetermined emission spectrum, and wherein the observation of this emission spectrum is employed to determine the presence of ligated first and second oligonucleotides in step (b).

This invention also provides a method of determining whether a preselected nucleotide residue is present at a predetermined position within a nucleic acid comprising the steps of:
(a) contacting the nucleic acid, under hybridizing and DNA polymerization-permitting conditions, with (i) a DNA polymerase, (ii) an oligonucleotide (1) having affixed thereto a composition of matter of claim 1, and (2) having a hydroxyl 3′ terminus thereof, wherein the oligonucleotide hybridizes with the 3′ region of the nucleic acid molecule flanking the predetermined position, and (iii) a dideoxynucleotide labeled with an isolation-permitting moiety, wherein the labeled dideoxynucleotide is complementary to the given nucleotide residue,
with the proviso that upon hybridization of the oligonucleotide with the nucleic acid in the presence of DNA polymerase and the preselected nucleotide residue, the oligonucleotide and dideoxynucleotide are juxtaposed so as to permit their covalent linkage by the DNA polymerase;
(b) detecting the presence of a polymerization product comprising both the oligonucleotide and the dideoxynucleotide, the presence of such a polymerization product indicating the presence of the preselected nucleotide residue at the predetermined position.

This invention further provides a method of determining whether at various predetermined positions within a nucleic acid, a preselected nucleotide residue is present at such position, wherein the preselected nucleotide residue may vary at different predetermined positions which comprises determining whether each preselected nucleotide is present each predetermined position according to the instant method.

In one embodiment the DNA polymerase is thermo sequenase.

This invention further provides the instant method, wherein the dideoxynucleotide is selected from the group consisting of dideoxyadenosine triphosphate, dideoxycytidine triphosphate, dideoxyguanosine triphosphate, dideoxythymidine triphosphate, and dideoxyuridine triphosphate.

This invention further provides the instant method, wherein the composition of matter affixed to the oligonucleotide has a predetermined emission spectrum, and wherein the observation of this emission spectrum is employed to determine the presence of polymerization product in step (b).

This invention further provides the instant methods, wherein observing the predetermined emission spectrum is performed using radiation having a wavelength of between 200 and 1000 nm.

In one embodiment the radiation has a wavelength of 488 nm.

This invention further provides the instant methods, wherein observing the predetermined emission spectrum is performed using radiation having a bandwidth of between 1 and 50 nm.

In one embodiment the radiation bandwidth is 1 nm.

This invention further provides the instant methods, wherein the isolation-permitting moiety comprises biotin, streptavidin, phenylboronic acid, salicyihydroxamic acid, an antibody or an antigen.

This invention further provides the instant methods, wherein the isolation-permitting moiety is attached to the oligonucleotide via a linker molecule.

This invention further provides the instant methods, wherein the isolation-permitting moiety is attached to the dideoxynucleotide via a linker molecule.

This invention further provides the instant methods, wherein the linker molecule is chemically cleavable.

This invention further provides the instant methods, wherein the linker molecule is photocleavable.

This invention further provides the instant methods, wherein the linker molecule has the structure:

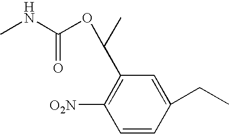

This invention will be better understood from the Experimental Details which follow. However, one skilled in the art will readily appreciate that the specific methods and results discussed are merely illustrative of the invention as described more fully in the claims which follow thereafter.

Experimental Details

I. The Design of Combinatorial Fluorescence Energy Transfer Tags

Background: Optical interactions persist between two chromophores even when they are as far as 80 angstroms apart. The chromophore with high energy absorption is defined as a donor, and the chromophore with lower energy absorption is defined as an acceptor. Fluorescence energy transfer is mediated by a dipole-dipole coupling between the chromophores that results in resonance transfer of excitation energy from an excited donor molecule to an acceptor (Forster, 1965). Forster established that the energy transfer efficiency is proportional to the inverse of the sixth power of the distance between the two chromophores. Fluorescence resonance energy transfer has been used extensively as a spectroscopic ruler for biological structures (Stryer, 1978), and energy transfer-coupled tandem phycobiliprotein conjugates have found wide applications as unique fluorescent labels (Glazer and Stryer, 1983). A set of polycationic heterodimeric fluorophores that exploit energy transfer and have high affinities for double-stranded DNA were also developed, offering advantages over monomeric fluorophores in multiplex fluorescence labeling applications (Benson et al., 1993; Rye et al., 1993). By exploiting fluorescence energy transfer principle, using a common donor and four different acceptors, four sets of ET primers and dideoxynucleotides were constructed that are markedly superior to single dye labels in DNA sequencing, and in multiplex polymerase chain reaction (PCR)-based mapping and sizing protocols (Ju et al., 1995, 1996).

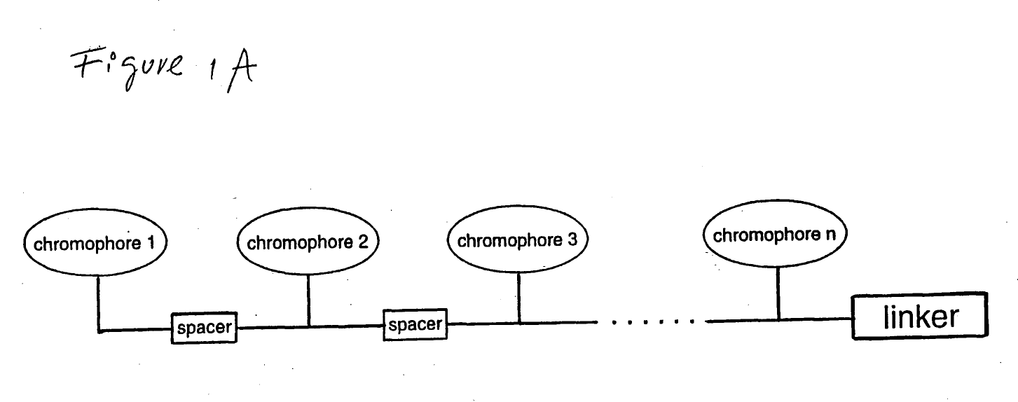

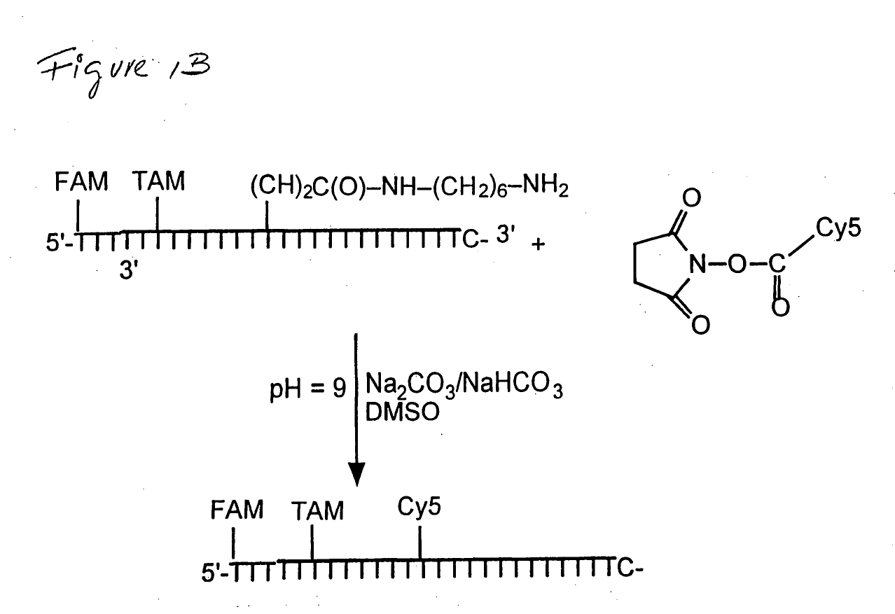

The present application discloses how energy transfer and combinatorial concepts can be used to tune the fluorescence emission signature of fluorescent tags for the development of a large number of combinatorial fluorescence energy transfer (CFET) tags. A schematic construction of the tags is shown in FIG. 1a. Representative examples for the construction of the CFET tags and their expected fluorescence signatures are shown in Table 1. Three individual fluorescent dyes, 6-carboxyfluorescein (FAM or F), N,N,N′,N′-tetramethyl-6-carboxyrhodamine (TAM or T) and Cyanine dye (Cy5 or C) are selected as examples to construct the CFET tags. The fluorescence emission maxima for FAM, TAM and Cy5 are 525 nm, 580 nm and 670 nm, respectively. Chemical moieties used as spacers are selected to construct various CFET tags aimed at conveniently labeling biomolecules and other targets of interest, monomers are convenient to employ. Other spacer moieties include nucleotides, peptides and 1′2′-dideoxyribose phosphates. As shown in Table 1, tag 1 is constructed with FAM alone and displays its characteristic fluorescence signature (λmax=525 nm). Any fluorophore with a characteristic fluorescence signature could be used in place of FAM. With FAM as a donor and TAM as an acceptor, CFET tags 2, 3, 4, and 5 can be constructed by changing the distance “R” between the FAM and TAM chromophores. The rationale is that altering the distance between donor and acceptor changes the energy transfer efficiency, and therefore the ratio of the fluorescence emission intensity of the donor (FAM) and acceptor (TAM) Similarly, with FAM as a donor and Cy5 as an acceptor, CFET tags 6, 7 and 8 can be generated. With three dyes, with FAM as a donor, TAM as an acceptor for FAM and as a donor for

TABLE 1
Representative Example of CFET Tags

| | | |
|---|---|---|
| CFET Tag | Fluorescence Signature | Tag ID |

| | | |
|---|---|---|
| 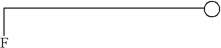 | 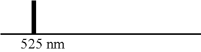 | 1 |
| 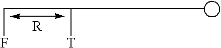 | 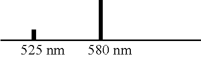 | 2 |
| 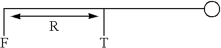 | 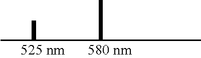 | 3 |
| 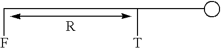 | 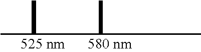 | 4 |
| 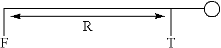 | 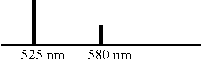 | 5 |
| 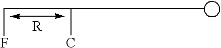 | 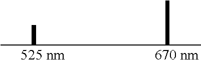 | 6 |
| 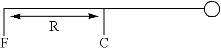 | 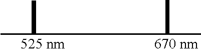 | 7 |
| 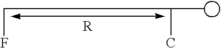 | 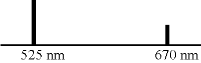 | 8 |
| 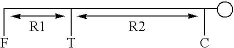 | 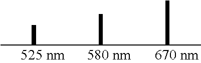 | 9 |
| 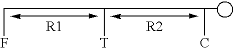 | 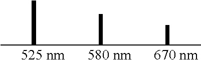 | 10 |

Cy5, which acts as the final acceptor, CFET tags 9 and 10 can be constructed by manipulating distances “R1” and “R2”. All the CFET tags can be excited with a single laser source and analyzed by simple detectors capable of capturing the emission signatures from each tag. In other embodiments, more than three dyes can be used. Alternatively just single chromophores can be used as long as they have unique fluorescence signatures.

The donor and acceptor fluorescent molecules are separated using convenient chemical moieties as spacers to tune the fluorescence signatures of the CFET tags. Examples of such spacer moieties include nucleotides, dideoxyribose phosphate, and amino acids. The construction of CFET tags involving three or more different dyes is more challenging, since synthetic procedures need to be designed for introducing the individual dye molecules at specific locations on the spacing backbone. As an example, CFET tags involving three dyes can be constructed using oligonucleotides as spacers. An oligonucleotide with the sequence 5′-TTTTTTTTTTTTTTTTTTTTTTTTTC-3′ (SEQ ID NO: 1) was selected as a scaffold to covalently attach FAM, TAM and Cy5. FAM is introduced by using a 6-FAM-dT phosphoramidite, TAM is introduced by using TAM-dT (Glen Research, Sterling, Va.), and a modified T having an amino linker at the C-5 position (Glen Research) is incorporated into the oligonucleotide which is then linked to Cy5-N-Hydroxy succinimide (NHS) ester. The final product is purified by size exclusion chromatography and gel electrophoresis. A representative reaction for the construction of CFET tag F-4-T-6-C (the numbers refer to the number of spacing nucleotides) involving FAM, TAM and Cy5 is shown in FIG. 1. By changing the spacing between FAM and TAM, and TAM and Cy5, two CFET tags F-4-T-6-C and F-7-T-3-C with the fluorescence signatures corresponding to tags 9 and 10 have been constructed as shown in FIG. 2. Shown are the ultraviolet/visible absorption spectrum of F-4-T-6-C (FIG. 2B) as well as the fluorescence emission spectra for F-4-T-6-C and F-7-T-3-C (FIGS. 2C and 2D), with excitation at 488 nm (1× Tris-Borate-Ethylenediaminetetraacetic acid (TBE) solution). The UV/visible spectrum exhibits the characteristic absorption of FAM at 495 nm, TAM at 555 nm and Cy5 at 649 nm (FIG. 2B). The fluorescence emission spectrum of F-4-T-6-C displays a fluorescence signature with Cy5 highest, TAM next and FAM lowest; whereas F-7-T-3-C displays a fluorescence signature with FAM highest, TAM next and Cy5 lowest. The two fluorescence signatures are clearly different, and easily discernible by spectroscopic methods. Here the feasibility of the CFET approach involving three different dyes is clearly demonstrated.

It is evident that one can synthesize broad families of CFET tags. Examples of two synthetic approaches for constructing CFET tags are shown: (1) 1′,2′-dideoxyribose phosphate monomer can be used as a spacer to separate dyes used for labeling oligonucleotide primers, which can be assembled on a DNA synthesizer; (2) a rigid peptide linker can be used to construct a CFET cassette to label any other molecular targets.

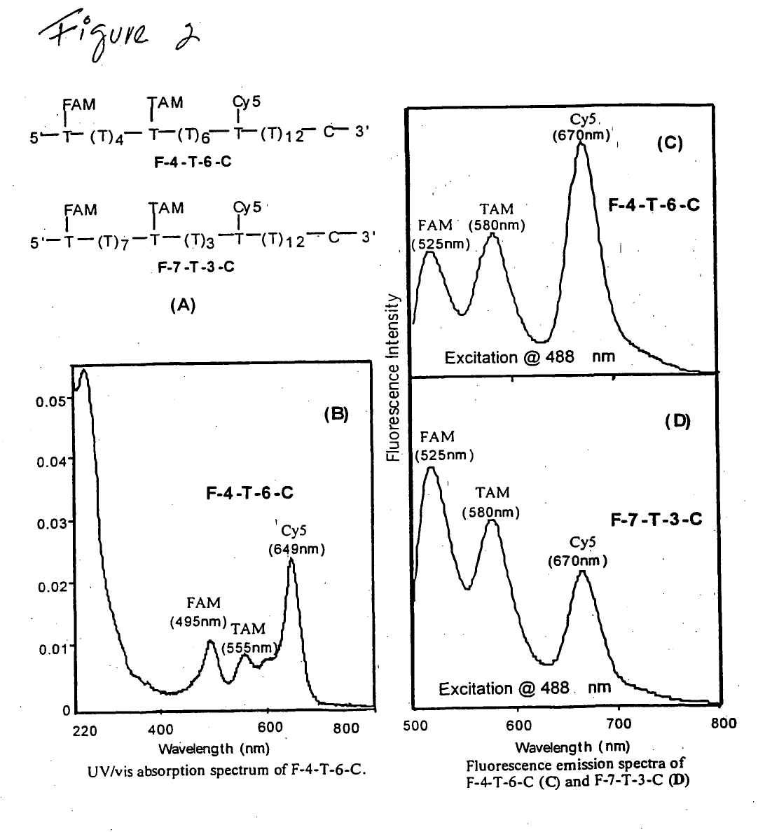

The first example is shown in FIG. 3A. A polymer linker (SSS . . . SSSS) formed by 1′,2′-dideoxyribose phosphates (S) at the 5′ end of the desired primer sequence forms a universal spacer for attaching the ET-coupled fluorophores, thereby producing an ET cassette. The 1′,2′-dideoxyribose phosphates can be introduced using 5′-dimethoxytrityl-1′,2′-dideoxyribose-3′-[(2-cyanoethyl)-(N,N-diisopropyl)]-phosphoramidite (dSpacer CE Phosphoramidite, Glen Research, Sterling, Va.). dSpacer CE Phosphoramidite has previously been used to construct DNA sequencing primers (Ju et al., 1996). In this CFET tag construction, FAM is used as a common donor. In a CFET tag consisting of two different fluorescent dyes, either TAM or Cy5 can be used as acceptors; whereas in a CFET tag consisting of three different fluorescent dyes, TAM can also be used as a donor for Cy5. The length of the spacing between each donor/acceptor pair can be changed systematically to achieve the expected fluorescence signatures as shown in Table 1. FAM and TAM can be introduced using phosphoramidite FAM-dT and TAM-dT and Cy5 can be introduced to the modified T carrying an amino linker as described above. The use of such spacers is advantageous in several aspects: (i) the spacer will not hybridize to any sequences within the DNA template and therefore false priming is avoided; (ii) the linkage of the spacer maintains the natural nucleic acid phosphate functionality, which avoids possible anomalies in electrophoretic mobility; and (iii) the elimination of the aromatic base groups on the deoxyribose rings in the spacer may reduce the likelihood of fluorescence quenching.

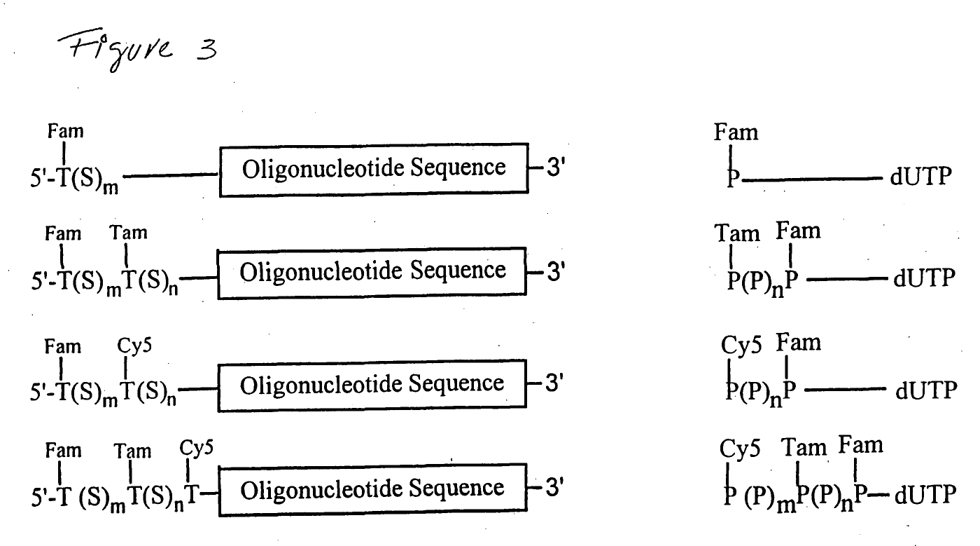

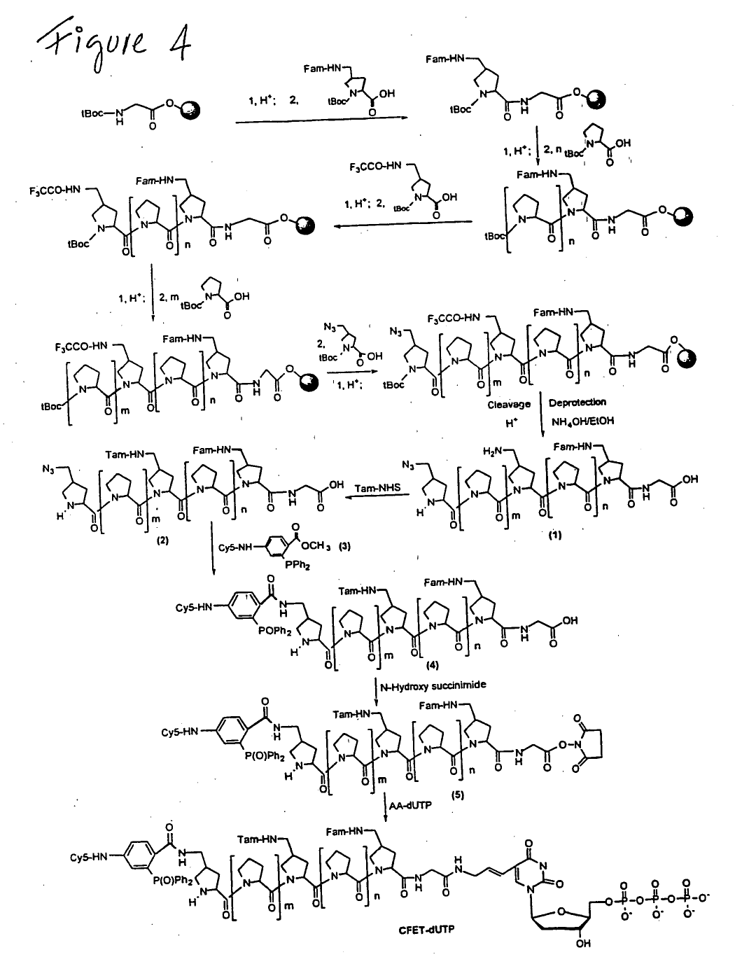

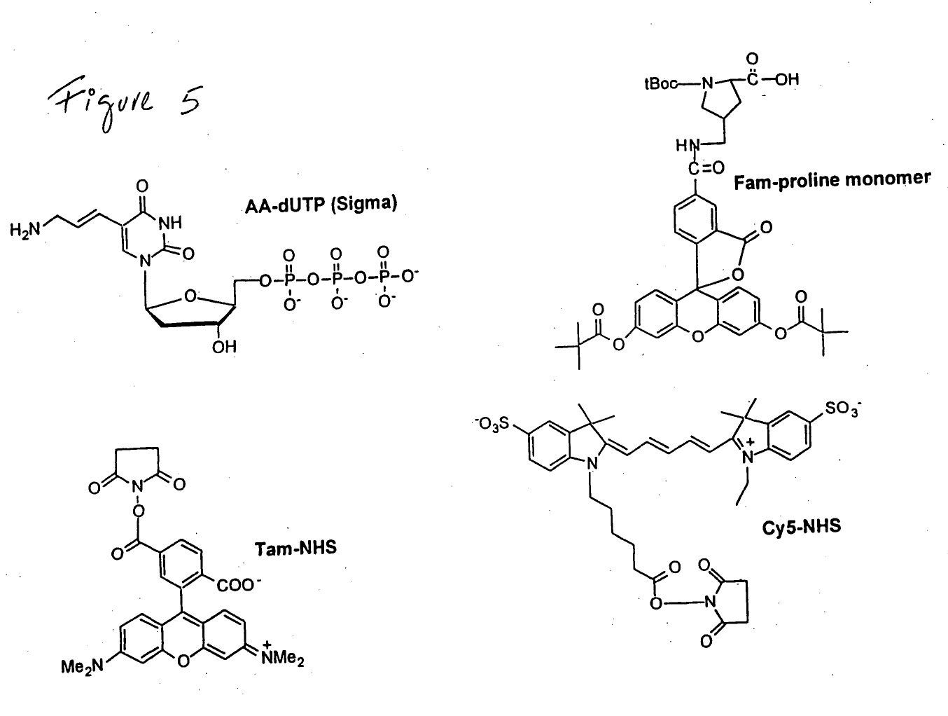

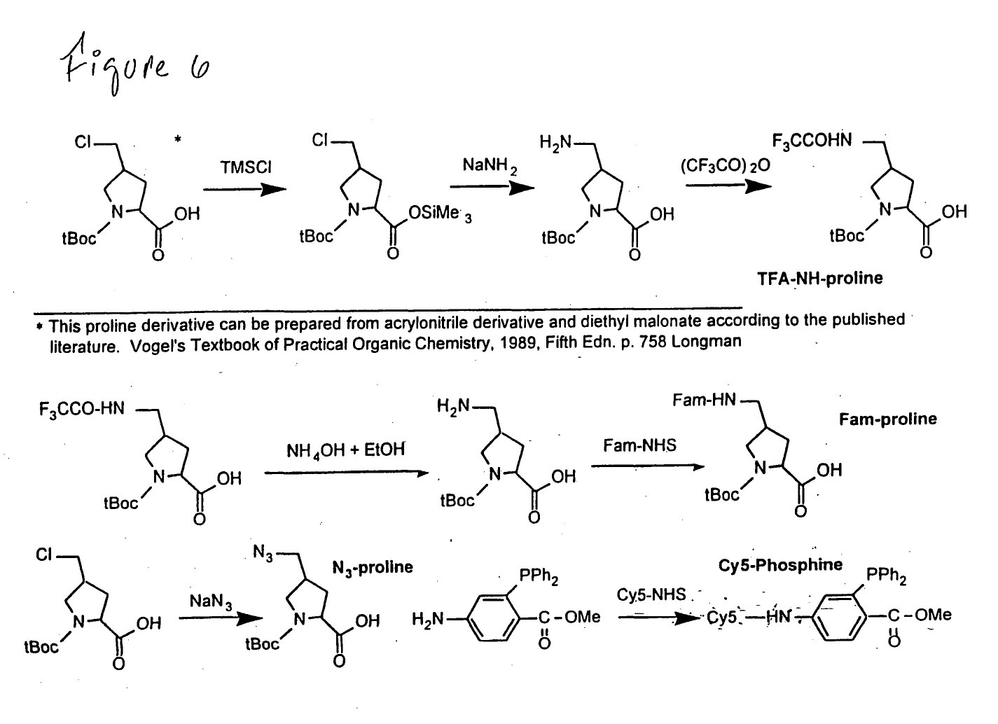

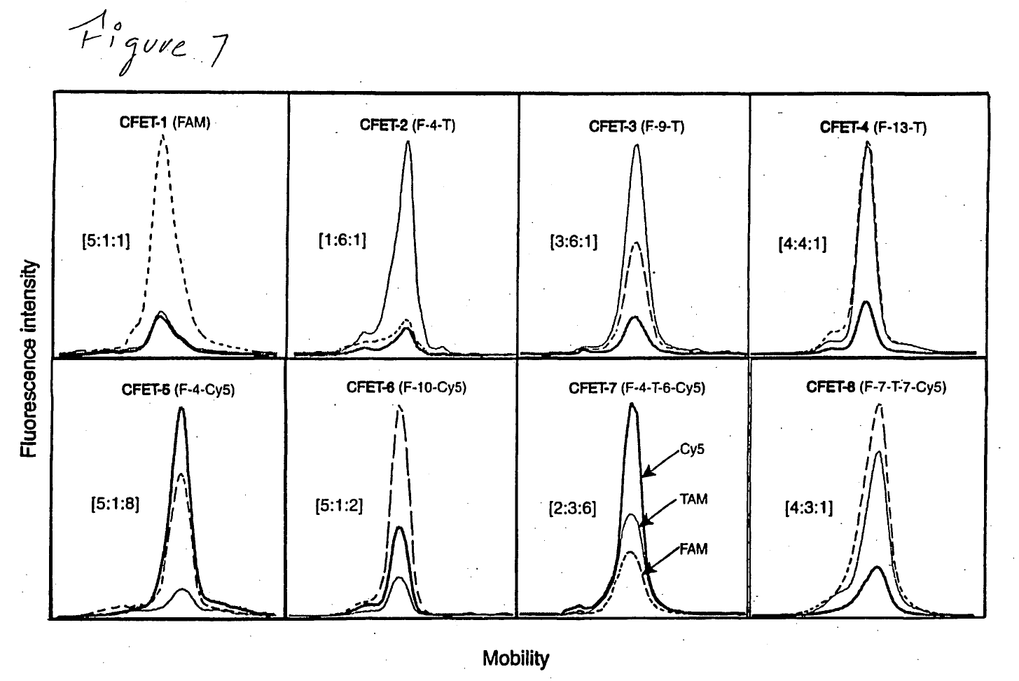

The second synthetic approach requires sophisticated selective synthetic chemistry procedures for the CFET tag construction. As an example, FIG. 3B shows a general scheme for the construction of CFET-deoxyuridine triphosphate (dUTP) using poly-proline (P) peptide as a spacer. The spacing between each donor/acceptor pair can be changed systematically to achieve the expected fluorescence signatures as shown in Table 1. FIG. 4 shows a scheme for the synthesis of CFET-dUTP consisting of Fam, Tam and Cy5. Peptide synthesis procedure using tert-butylcarbonyl (t-Boc) chemistry is employed on a peptide synthesizer to construct the scaffold of the desired molecules. Starting with a glycine-resin as C-terminal, a modified proline tagged with FAM (Fam-proline) is coupled to glycine, then proline monomers are added, followed by reacting with another modified proline that has a protected primary amino linker (TFA-NH-proline) for the subsequent incorporation of Tam. Next, proline spacer is again added, followed by reacting with the azido-proline for the subsequent incorporation of Cy5. After cleavage from the resin and removal of the trifluoroacetyl group, compound 1 in FIG. 4 is obtained. Compound 1 reacts with TAM-NHS ester to form compound 2, which will then react with Cy5-phosphine (3) to produce compound 4, which has all the three dyes incorporated. Cy5-phosphine (3) can be synthesized using the modified Staudinger reaction developed by Bertozzi (Saxon and Bertozzi, 2000). Conversion of compound 4 to an NHS ester produces 5, which is then coupled to Aminoallyl (AA)-dUTP (Sigma) to generate the final product CFET-dUTP. By varying the number of proline spacers between Fam and Tam, and between Tam and Cy5, a library of CFET-dUTPs with unique fluorescence signatures can be developed. The intermediates 2, 4, 5, and the final products can be purified by high pressure liquid chromatography (HPLC), size exclusion chromatography and gel electrophoresis. The structures of AA-dUTP, Fam-Proline, and NHS esters of TAM and Cy5 are shown in FIG. 5. Brief synthetic schemes for the synthesis of trifluoroacetic (TFA)-NH-proline, Fam-proline, azido-proline and Cy5-phosphine are shown in FIG. 6. Unique fluorescence signatures for 8 synthesized CFET tags are shown in FIG. 7.

II. Biomedical Applications of Combinatorial Fluorescence Energy Transfer Tags

The ability to sequence DNA accurately and rapidly is revolutionizing biology and medicine. The confluence of the massive Human Genome Project is driving an exponential growth in the development of high throughput genetic analysis technologies. This rapid technological development involving biology, chemistry, computer science, and engineering makes it possible to move from studying genes one by one to approaches which can analyze and compare entire genomes.

Sophisticated techniques have enabled large-scale dissection of genomes. For instance, the development of cloning vectors which can maintain and reproduce large stretches of DNA (up to a million bases) has resulted in clone libraries which span most of the chromosomes from end to end for many of the highly studied organisms including humans—so-called physical maps. Recognizing sequence markers that differ from one individual to another across the human genome has permitted them to be followed in families that harbor genetic diseases. If a marker cosegregates with the disease phenotype, one can be assured that the marker is in the vicinity of the gene responsible for that disease. Automated sequencing methods have made it possible to obtain the complete chemical composition of the genome with unprecedented speed, and computational approaches are beginning to allow annotation of these sequences, identification of the genes and other elements that comprise the chromosomes. Gene expression has moved from the arena of analyzing a few genes at a time by the techniques of Northern blot analysis, to creating vast microarrays of these genes on glass slides or silicon chips (Schena et al. 1995, Chee et al. 1996). Methods for identifying single nucleotide polymorphisms (SNPs) (Chen and Kwok, 1997), DNA-protein and protein-protein interactions (Uetz et al. 2000), and members of metabolic, signal transduction and other pathways are also being developed. All these advances will have the potential to revolutionize medical and clinical research in establishing diagnostic, prognostic or treatment options.

It is noteworthy that many of the genomic techniques mentioned have benefited from the use of novel molecular tags, especially fluorescent dye molecules. DNA sequencing serves as a good example for evaluating the impact of this technology. Although the ability to obtain DNA sequences originated in the late 1970's with the development of the chemical cleavage approach of Maxam and Gilbert (1977) and the dideoxynucleotide terminator approach of Sanger et al. (1977), it was the latter that was most amenable to automation and fluorescent labeling strategies. In the past 15 years, in rapid succession, the ability to use four dyes in a single sequencing lane, one for each of the four bases in DNA (Smith et al. 1986), the ability to use cycle sequencing with heat stable enzymes (Tabor et al. 1995), the development of energy transfer dyes which produced higher signals (Ju et al., 1995; Lee et al., 1997), and more recently, the ability to obtain long sequence reads in separate capillary tubes instead of adjacent lanes on polyacrylamide slab gels, has made sequencing increasingly robust. Future improvements in sequencing technology, including miniaturization and solid phase approaches, will continue to take advantage of energy transfer (ET) and other novel fluorescent tags (Ju et al., 1997). Investigators are also utilizing ET dyes for investigating gene expression on microarrays (Hacia et al. 1998). All of these approaches are believed to be limited to single pairs of donor and acceptor dyes for each reaction. The CFET approach described herein whereby one, two or more dyes, disposed at varying molecular distances from each other to generate many alternative discrete signatures offers the possibility of obtaining an order of magnitude higher-throughput in many of these genomic approaches. Genetic mutation and chromosome analysis are two examples of the biomedical application of these CFET tags. Using CFET tags in combination with single fluorophore tags, and/or multiple dye tags where no FET occurs, the number of possible unique fluorescence signatures, and hence the number of e.g. SNPs detectable simultaneously, is hugely increased.

Gene mutations play important roles in the development of many human diseases. It has become increasingly apparent that missense mutations (single base changes usually culminating in amino acid changes or introduction of stop codons which lead to truncated proteins), microdeletions and microinsertions (both of which can change the reading frame and also usually lead to protein truncation) can occur at many positions along the length of the responsible gene. A number of studies have sought to identify causative mutations and predisposing polymorphisms for a number of cancers and other diseases. These include chronic lymphocytic leukemia and other blood cancers (Kalachikov et al. 1997; Qu et al. 1998), the long QT syndrome (an ionic disturbance in the heart visible on electrocardiograms and an important risk factor for sudden cardiac death), breast cancer (Fischer et al. 1996), the rare ICF syndrome (immune deficiency/centromeric instability/facial anomalies) (Xu et al. 1999), and more recently such complex disorders such as asthma and diabetes.

With the exception of the types of small mutations described above and single nucleotide polymorphisms that occur, on average, every 1000 nucleotides, the 6 billion nucleotide pairs that make up the diploid human genome are largely identical from individual to individual. Nonetheless, large deletions, amplifications and rearrangements do occur, and such chromosomal anomalies are often associated with serious and life-threatening diseases. The best known example is probably the third copy of chromosome 21 in individuals with Down syndrome, but many other chromosomal translocations and macrodeletions are associated with cancer and other disease syndromes. If one is able to mark the positions along chromosomes with identifiable “color-coded” probes, it should be possible to easily detect such large-scale changes in chromosomal geography. In fact, the field of chromosome painting (multicolor fluorescence in situ hybridization (M-FISH) has been used for just such analyses (Speicher et al. 1996). A larger set of more readily separable CFET tag signatures might greatly aid in this enterprise. The established chromosome painting techniques require appropriate mixing of the different dyes prior to labeling, and so are used almost exclusively for labeling whole chromosomes.

III. CFET Tags for Multiplex Gene Mutation Detection Using Ligase Chain Reaction

Ligase chain reaction (LCR) is a procedure for genetic mutation analysis using ligase and a pair of oligonucleotides (Eggerding, 1995; Wu and Wallace, 1989; Landegren et al., 1988). Briefly, it is based on the fact that two adjacent oligonucleotides can only be ligated if the adjoining bases are complementary to the template strand. If there is a single base difference within two bases of the join site, ligation will not occur. Pairs of oligonucleotides are designed spanning the ligation site on the template DNA, including one harboring either the wild-type or mutated base. In the usual procedure, one of the oligonucleotides is radiolabeled at the phosphate group at its 5′ end. Following the ligase chain reaction, which involves multiple rounds of denaturing, primer annealing and ligation, one can separate the products from the substrates on polyacrylamide gels. The procedure can be modified using single stranded DNA template as shown in FIG. 8 for testing using the CFET tags. Primer pairs are generated surrounding a base that can be mutated. For example, the template may contain a T (wild-type, wt) or C (mutated, mut) at the relevant position. The wt primers are complementary to the wt template at every position. The primer on the right side of FIG. 8A is labeled with CFET tag 1 to yield a specific fluorescent signature. The mutation-specific primer, two bases longer than its wild-type analog, is complementary to every position of the mutated template. This primer is labeled with CFET tag 2 displaying another unique fluorescent signature. A common 20 base pair primer will be used on the other side of the ligation site. In cases where ligation does not occur, because a wild-type oligonucleotide was used with a mutated template sequence, or a mutated oligonucleotide was used with a wild-type template sequence, the only fluorescent band on the acrylamide gel will be the size of the tagged primer. In contrast, if there is no mismatch at the ligation junction, two fluorescent bands, one the size of the primer and one the size of the joined primers will form. Following ligase chain reaction, the left and right primer will be ligated only if they are completely complementary to the template. Thus, with a wt template, only a 40 base product will result, and only a 42 base product will result from a mut template as shown in FIG. 8B. By virtue of the unique fluorescence emission signatures of the CFET tags, it is possible to display the products of several mutation positions simultaneously, each labeled with a different CFET Tag. The ligated products can be separated and analyzed in a single gel lane. In order to accomplish this, the multiplex set of oligonucleotides that contain the potentially mutated position can be 5′-end labeled, each with a specific CFET tag. For example, one can test four different mutation sites using eight distinct CFET tags.

As shown in Table 2, eight primers labeled with eight unique CFET tags (1, 2, 3, 4, 5, 6, 9, and 10 of Table 1) can be constructed as shown in the general labeling scheme in FIG. 3A using 1′,2′-dideoxysugar phosphate (S) as spacers. For this set of CFET tag constructs, FAM is used as a common donor, and TAM and/or Cy5 as acceptors. The length of the spacing between each donor/acceptor pair, (S)m and (S)n, can be changed systematically to achieve the expected fluorescence signatures as depicted in Table 1. FAM and TAM can be introduced using FAM-dT and TAM-dT phosphoramidites and Cy5 can be introduced to the modified T carrying an amino linker as described above.

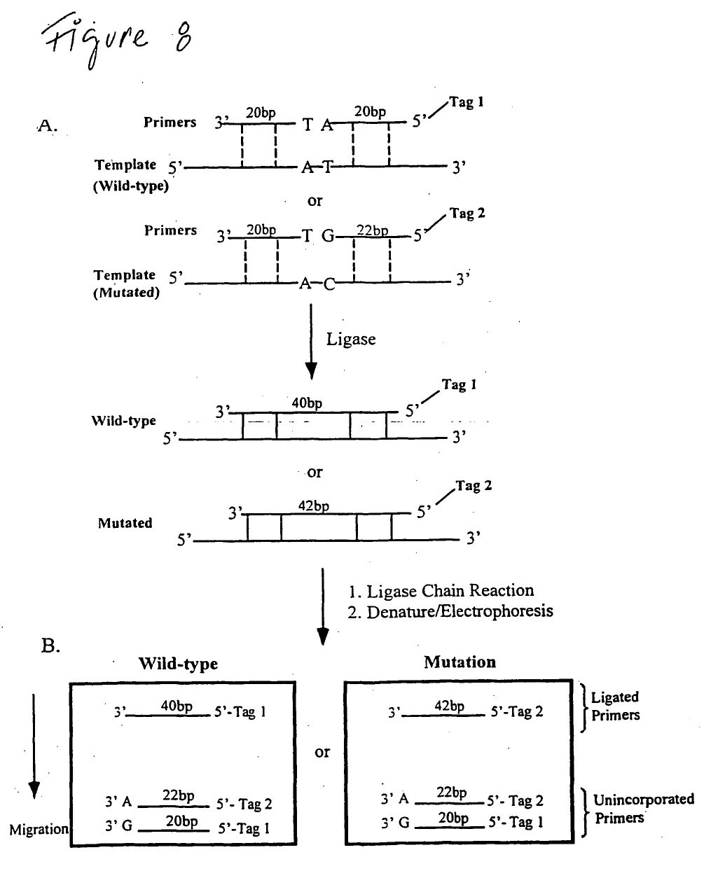

The system can be tested, for example, by synthesizing single stranded DNA templates mimicking known single base mutations in exon 20 of the retinoblastoma susceptibility (RB1) gene (Schubert et al. 1994, Lohmann 1999). The sequences of two sets of synthetic templates (wt and mut) which can be used in the analysis are shown in Table 3. The sequence of the potential mutation positions is shown in bold-face as “A”, “C”, “G” and “T”. Primer sets 1 and 2 in Table 2 are used for the testing of both wild type and mutated base positions of Template A, respectively; while primer sets 3 and 4 are for testing both wild type and mutated base positions of Template B, respectively. To maximize the number of samples that can be detected on a polyacrylamide gel, the primers surrounding each “mutated” position can be designed to be a unique length as shown in FIG. 9. For example, the two CFET labeled oligonucleotides (one for the wild-type gene and one for the mutated gene) surrounding mutation position 1 are 20 and. 22 bases long, respectively, and the unlabeled common primer is 20 bases long. Any resulting ligation product will be either 40 or 42 bases long. Likewise, for mutation position 2, 24 and 26 base labeled oligonucleotides can be constructed, as well as a different 20 base common primer, leading to ligation products of either 44 or 46 bases. More primers can, of course, be generated by making the sizing increment one base instead of two bases for each different mutation, or creating a second set of labeled primers whose ligation products run between 80 and 98 base pairs, between 120 and 138 base pairs, etc. Since single base pair resolution up to the length of ˜400 bp DNA fragments is easily achieved in polyacrylamide gel electrophoresis, the ligated products can be readily resolved in such standard fluorescent gel systems. Furthermore, the advantage of being able to clearly distinguish the products based on their fluorescent signatures, as well as size, makes this assay extremely powerful. Expected gel electrophoresis results for this multiplex testing system are shown on the right side of FIG. 9. Here, template collection 1 is seen to contain only wt sequences. In contrast, template pool 2 contains one template with a mutation at position 2 and a heterozygote genotype at position 4.

TABLE 2

Eight primers used for multiplex mutation
detection

| | | |
|---|---|---|
| Primer 1L: | 3′-ttaaaaagaataagggtg | (SEQ ID NO:2) |
| | tc-5′ | |
| Primer 1R wt: | 3′-Acatagccgatcggatag | (SEQ ID NO:3) |
| | ag-5′-CFET1 | |
| Primer 1R mut: | 3′-Tcatagccgatcggatag | (SEQ ID NO:4) |
| | aggc-5′-CFET2 | |
| Primer 2L: | 3′-acatagccgatcggatag | (SEQ ID NO:5) |
| | ag-5′ | |
| Primer 2R wt: | 3′-Gccgatttatgtgaaaca | (SEQ ID NO:6) |
| | cttgcg-5′-CFET3 | |
| Primer 2R mut: | 3′-Accgatttatgtgaaaca | (SEQ ID NO:7) |
| | cttgcgga-5′-CFET4 | |
| Primer 3L: | 3′-cggaagacagactcgtgg | (SEQ ID NO:8) |
| | gt-5′ | |
| Primer 3R wt: | 3′-Cttaatcttgtatagtag | (SEQ ID NO:9) |
| | acctgggaaa-5′-CFET5 | |
| Primer 3R mut: | 3′-Attaatcttgtatagtag | (SEQ ID NO:10) |
| | acctgggaaaag-5′-CFET6 | |
| Primer 4L: | 3′-atagtagacctgggaaaa | (SEQ ID NO:11) |
| | gg-5′ | |
| Primer 4R wt: | 3′-Tcgtgtgggacgtcttac | (SEQ ID NO:12) |
| | tcatacttgagt-5′- | |
| | CFET9 | |
| Primer 4R mut: | 3′-Gcgtgtgggacgtcttac | (SEQ ID NO:13) |
| | tcatacttgagtac- | |
| | 5′CFET10 | |

TABLE 3

The sequence of the two sets of synthetic
templates (wt and mut)

| | |
|---|---|
| Template A: | |
| 5′-gtaaaaatgactaatttttcttattcccacagT | (SEQ ID NO:14) |
| gtatcggctagcctatctcCggctaaatacactttg | |
| tgaacgccttctgtctgagcacccagaatta-3′ | |
| (wild type) | |
| 5′-gtaaaaatgactaatttttcttattcccacagA | (SEQ ID NO:15) |
| gtatcggctagcctatctcTggctaaatacactttg | |
| tgaacgccttctgtctgagcacccagaatta-3′ | |
| (mutated) | |
| Template B: | |
| 5′-tacactttgtgaacgccttctgtctgagcaccc | (SEQ ID NO:16) |
| aGaattagaacatatcatctggacccttttccAgca | |
| caccctgcagaatgagtatgaaCtcatgaga-3′ | |
| (wild type) | |
| 5′-tacactttgtgaacgccttctgtctgagcaccc | (SEQ ID NO:17) |
| aTaattagaacatatcatctggacccttttccCgca | |
| caccctgcagaatgagtatgaactcatgaga-3′ | |
| (mutated) | |

IV. CFET Tag Labeled Probes for Chromosome-Wide Analysis

Probes can be generated using a random primed labeling method to incorporate CFET-dUTP into chromosome-specific DNA molecules or cosmids disposed along the length of a given chromosome. Metaphase spreads of fresh cells or deparaffinized material can be prepared by standard methodologies, and the tagged probes can be hybridized to the chromosomes. Bulky ET dyes consisting of two individual fluorescent molecules, as well as dyes with a long linker, have been attached to deoxynucleotides (dNTPs) and dideoxynucleotides (ddNTPs) which have been shown to be good substrates for DNA polymerase (Rosenblum et al. 1997, Zhu et al. 1994). Thus, the CFET-dUTP should be able to be incorporated into the growing strand by the polymerase reaction. In the actual random priming reaction, the ratio of regular deoxythymine triphosphate (dTTP) and CFET-dUTP can be adjusted, so-that only a small portion of CFET-dUTP will be incorporated into the growing chain, just enough to be detected by the optical method.

Numerical and structural chromosome rearrangements are a major cause of human mortality and morbidity. Aneuploidy of whole chromosomes accounts for at least 50% of early embryonic lethality, and also leads to severe patterns of congenital malformation such as Down syndrome. Segmental aneuploidies due to deletions and duplications also lead to malformation syndromes, as well as being associated with many types of cancer.

Traditional cytogenetic analysis is hampered by problems of resolution and interpretation inherent in standard banding analysis. In the last decade the use of fluorescent labeled DNA probes on chromosome preparations as well as on interphase nuclei has greatly improved the resolution and accuracy of cytogenetic diagnosis. Microdeletions and amplifications too small to be visible under the light microscope by banding can now be visualized using chromosome and region specific fluorescently labeled probes. Multiplexing this system is possible using combinations of probes labeled with different fluors. Sets of up to five differently labeled probes have been used for diagnostic purposes on interphase nuclei to determine aneuploidy in prenatal samples (Munne et al. 1998). M-FISH and Spectral Karyotyping use a combinatorial approach of five dyes to “paint” all 23 pairs of human chromosomes so they can be distinguished using computerized image software (Schrock et al. 1996, Speicher et al. 1996). However, these established techniques require careful mixing of dyes in controlled ratios. Quality control is often a problem, and the commercially available probes are very expensive.

CFET Tags are expected to have a substantial advantage over currently available dye sets. It should be possible to generate a larger number of CFET tag sets, reducing the need for a combinatorial approach. Quality control is also likely to be easier, since each probe needs to be labeled with only one tag, and probe sets can be mixed in equal quantities to produce multicolor FISH reagents.

CFET Tags for example could be used both for the detection of aneuploidy in interphase nuclei, and for the detection of submicroscopic chromosomal deletions and amplifications. For aneuploidy detection, for example, a set of eight different CFET tag labeled probes can be prepared, each specific for one of the chromosomes most commonly involved in aneuploidy in either embryonic losses or birth defects (chromosomes 13, 15, 16, 18, 21, 22, X and Y).

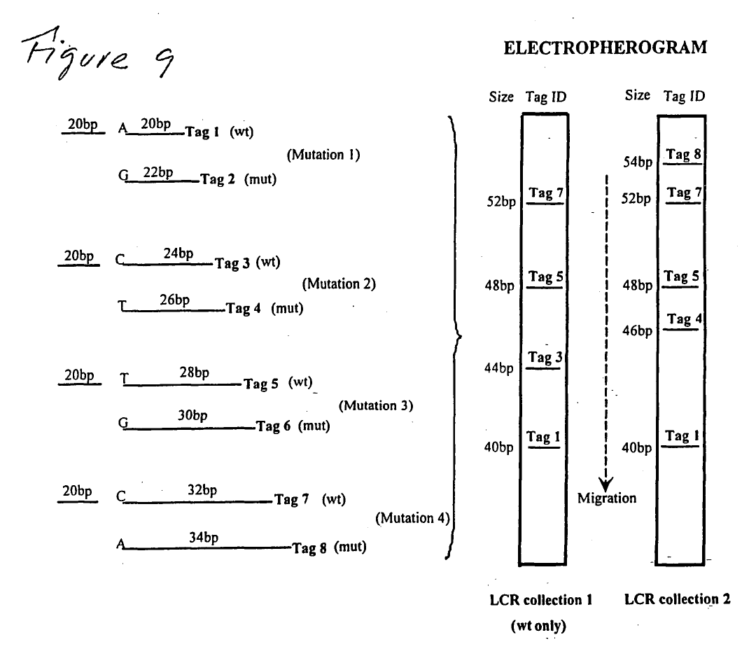

A schematic of a procedure for comprehensive chromosome-wide analysis for gain or loss of genetic material is shown in FIG. 10. In the example, eight probes each labeled with a CFET-dUTP that emits a unique fluorescence signature are hybridized along a chromosome in eight separate locations. The normal chromosome A will display eight unique fluorescence signatures of each probe in a defined order. A loss of fluorescence signature “2” in chromosome B will indicate the deletion of the complementary sequence of probe 2. Whereas, in chromosome C, the appearance of two signatures of “3” will indicate the expansion of the complementary sequences for probe 3.

Standard sets of cosmid and BisAcryloylcystamine (BAC) markers at 2-3 Mb intervals along the chromosomes are being developed in several laboratories, including a National Cancer Institute sponsored project, the Cancer Chromosome Aberration

Project (CCAP: webpage www.ncbi.nlm.nih.gov/ncicgap/). Sets of differentially CFET-labeled ordered probes specific for particular chromosomal regions can be prepared. Using FISH, one can then determine the limits of suspected or known deletions.

V. Use of CFET Tags in other Multi-Component Analyses

The CFET tags with unique fluorescence signatures which are disclosed in the present application will have utility in other applications involving multi component analysis in addition to those disclosed above. Additional applications include, but are not limited to, multiplex assays including binding assays and immuno assays, detection of microbial pathogens, monitoring multiple biomolecular reactions, screening of drugs or compounds, epitope mapping, allergy screening, and use with organic compounds and in material science. For example, multiple reactions or interactions can be measured simultaneously, where multiple CFET tags, each with a different fluorescence signature, are used to label the different reactants which could include, for example, antibodies, antigens, ligands, or substrates. Examples include antibody-antigen and receptor-ligand binding. In further examples, different reactants can be coupled to microspheres.

VI. CFET Tags Used in Ligation Assay to Identify Multiple Single Nucleotide Polymorphisms.

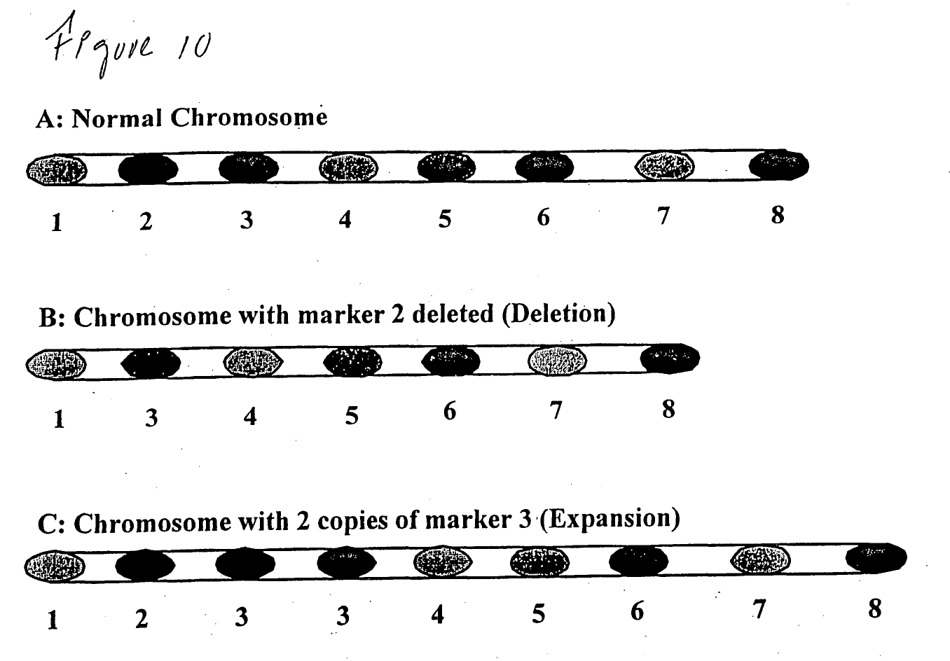

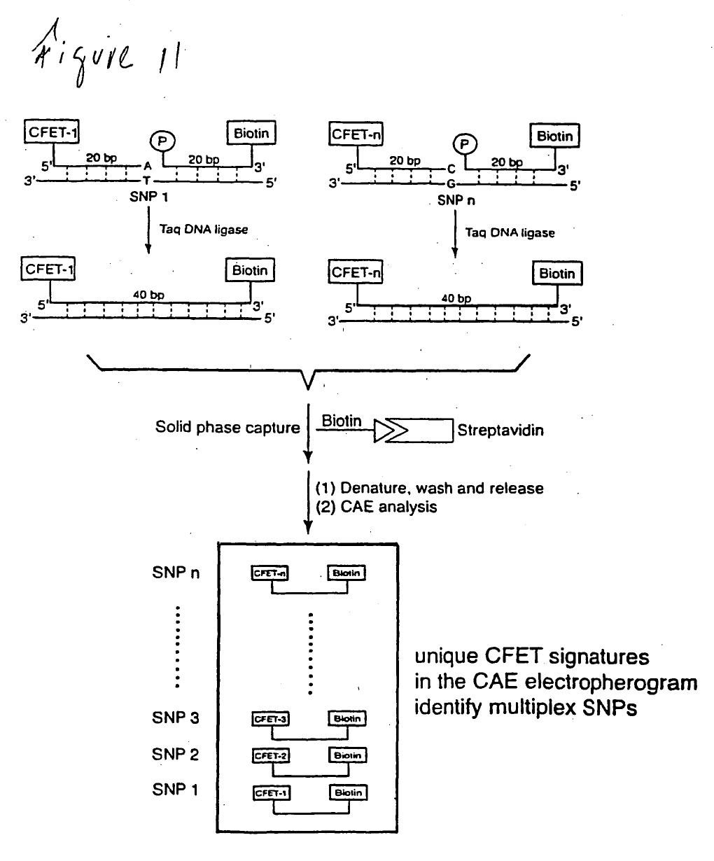

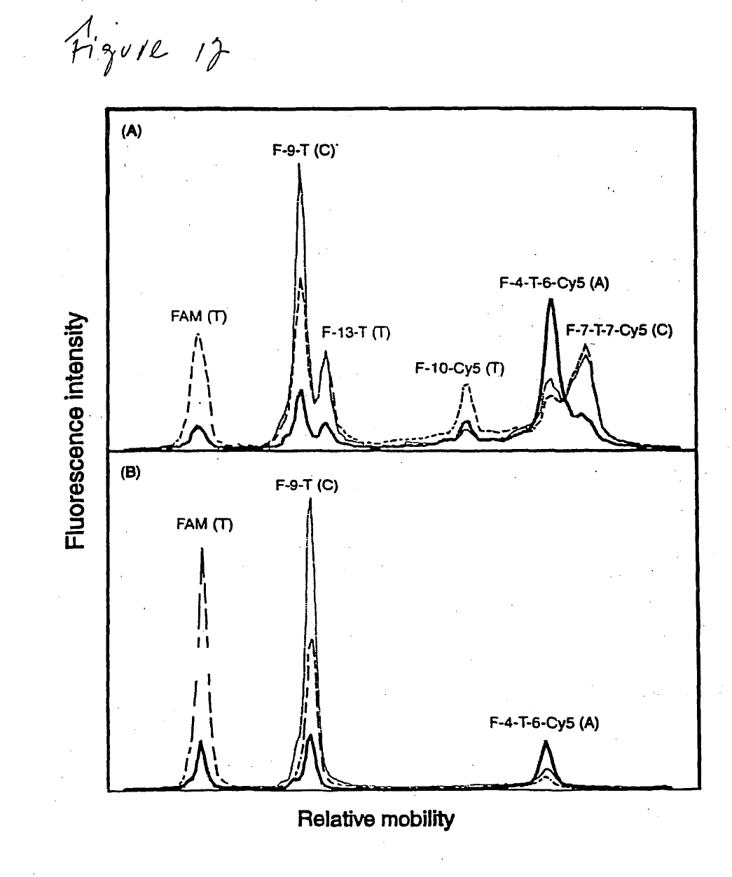

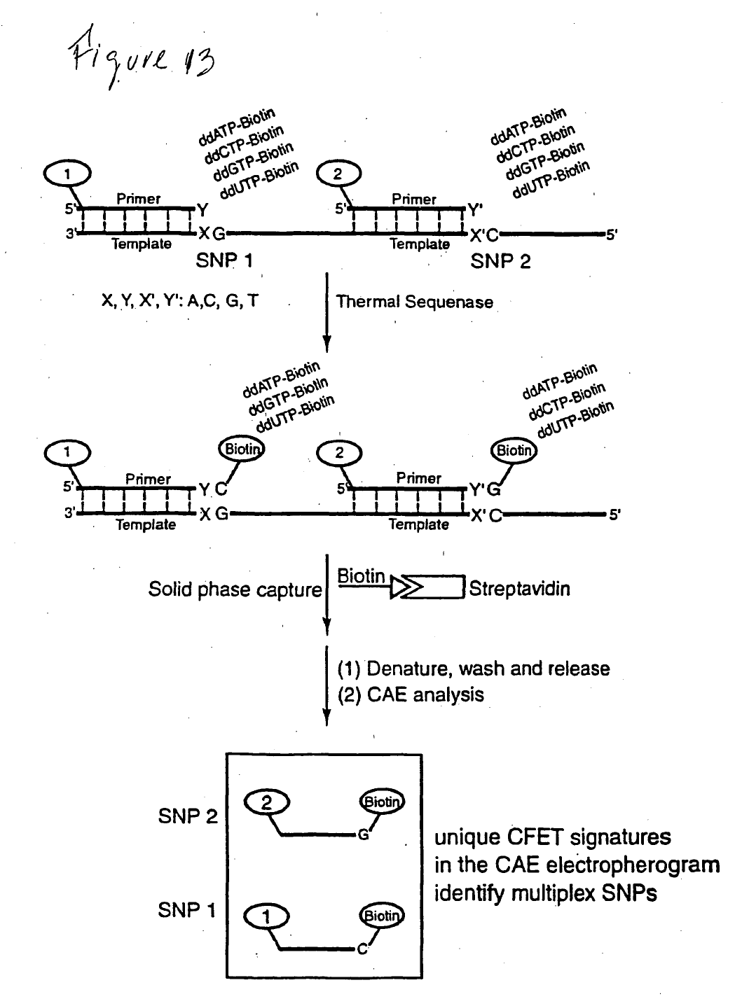

As an example of application for biological assays, the CFET tags were applied to an oligonucleotide ligation assay (Landegren, 1988) coupled with solid phase purification to detect genetic mutations on exon 20 of the tumor suppressor retinoblastoma (RB1) gene. The schematic of the approach is shown in FIG. 11. Two 20 base-pair oligonucleotides, one labeled with a CFET tag at the 5′ end and the other labeled with a biotin at the 3′ end and a monophosphate (P) group at the 5′ end, are hybridized to the target DNA template such that the 3′ end of the CFET-labeled oligonucleotide is positioned next to the 5′ end of the biotinylated oligonucleotide. Taq DNA ligase joins the two juxtaposed oligonucleotides in a head-to-tail fashion by forming a phosphodiester bond, provided that the nucleotides at the ligating junction of the two oligonucleotides are correctly base-paired with the template (Barany, 1991). Under the experimental conditions using Taq DNA ligase, no ligation reaction occurs when there is a mismatch between the 3′ end of the CFET-labeled probe (nucleotides A and C, FIG. 11) and the SNP site (nucleotides T and G, FIG. 11) on the target template. After the ligation, the CFET-labeled ligation products (40 base-pair) are immobilized to streptavidin-coated magnetic beads while the other components are washed away. The ligation products are then cleaved from the magnetic beads by denaturing the biotin-streptavidin interaction with formamide and analyzed with a three-color fluorescence CAE system. The CFET-labeled ligation products are unambiguously detected due to their distinct mobility and unique fluorescence signatures in the electropherogram, see FIG. 12. In the case of heterozygotes at the SNP site, two CFET tags with different fluorescence signature and electrophoretic mobility are used to label the oligonucleotides corresponding to each allele. The unique fluorescence signatures in the electropherogram thus identify each of the corresponding SNPs. The solid phase procedure completely eliminates the unligated CFET-labeled oligonucleotide. Although the unligated 20 base-pair biotinylated oligonucleotides are also captured by the magnetic beads, they do not produce fluorescence signals due to the absence of CFET tags. The CFET tag library in this application detects multiple SNPs on the target DNA template simultaneously.

Exon 20 of the tumor suppressor RB1 gene (Schubert, 1994) was selected as a model system to test the utility of the CFET tags. Several SNPs within a region of 200 base pairs in the RB1 gene have been found, which are well suited for evaluating a genetic mutation analysis system. Six ligation reactions were carried out separately using six different CFET tags on synthetic templates mimicking exon 20 of the RB1 gene where multiple SNPs (six nucleotide variations) are located. After the ligation and solid phase purification, the ligation products were combined in a single tube and analyzed with a three-color CAE system, resulting in the simultaneous detection of six nucleotide variations by the unique fluorescence signatures of the CFET-labeled ligation products (see FIG. 12A). The unique fluorescence signatures were spatially resolved in the electropherogram as a result of the different mobility of the CFET-labeled ligation products. In this model experiment, both CFET-1 (FAM) and CFET-6 (F-10-Cy5) detect homozygous SNPs (T/T). CFET-3 (F-9-T) and CFET-4 (F-13-T) clearly distinguish a mimic of RB1 gene mutation R661W (amino acid change from arginine to tryptophan due to mutation in codon 661) by detecting both the wild type (C) and-the mutation (T). CFET-7 (F-4-T-6-Cy5) and CFET-8 (F-7-T-7-Cy5) identify another mutation Q685P (amino acid change from glutamine to proline due to mutation in codon 685) with heterozygous genotype (A/C). To validate the CFET technology further used three CFET-labeled oligonucleotide probes (CFET-1, 3 and 7) and their corresponding biotinylated oligonucleotides to identify three SNPs using a PCR product amplified from exon 20 of the RB1 gene from patient-genomic DNA. The ligation reactions were performed in a single tube and the reaction products were loaded onto a three-color CAE system. Three individual homozygous SNPs (T, C and A), that were verified by DNA sequencing, were unambiguously identified by the three distinct fluorescence signatures from the CFET tags (FIG. 12B): T (FAM, CFET-1), C (F-9-T, CFET-3) and A (F-4-T-6-Cy5, CFET-7). Thus, the approach described here can detect both heterozygotes and homozygotes unambiguously because of the unique CFET fluorescence signature and mobility in the electropherogram.

To increase the level of control available in isolation other isolation-permitting moieties besides biotin may be employed such as phenylboronic acid. Attachment of the moieties via cleavable linker molecules enhances this still further.

VII. CFET Tags Used in Single Base Primer Extension to Identify Multiple Single Nucleotide Polymorphisms.

Single base extension for each dye-labeled primer was done by mixing 0.5 to 1 pmol of the primers with 1 pmol of template, followed by adding 2 μl of thermo sequenase 10× reaction buffer (260 mM Tris-HCl, 65 mM MgCl₂, pH 9.5, Amersham Pharmacia Biotech, Piscataway, N.J.), 5 μl of water, 1 pmol of biotinylated dideoxynucleoside triphosphates (Biotin-11-ddNTP, NEN, Boston, Mass.) and 1 unit of thermo sequenase in 20 mM Tris-HCl, pH 8.5, 50% glycerol, 0.1 mM ethylenediamine tetraacetic acid (EDTA), 0.5% Tween™-20 (v/v), 0.5% Nonidet™ P-40 (v/v), 1 mM dithiothreitol (DTT), 100 mM KCl and 0.053 unit/μl Thermoplasma acidophilum inorganic pyrophosphatase (Amersham Pharmacia Biotech). The reaction mixture was incubated at 54° C. for 30 sec for single base extension.

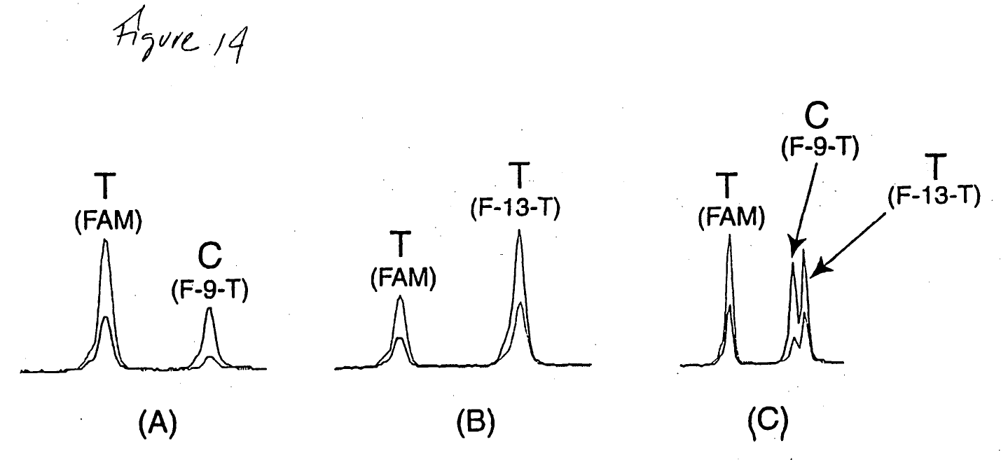

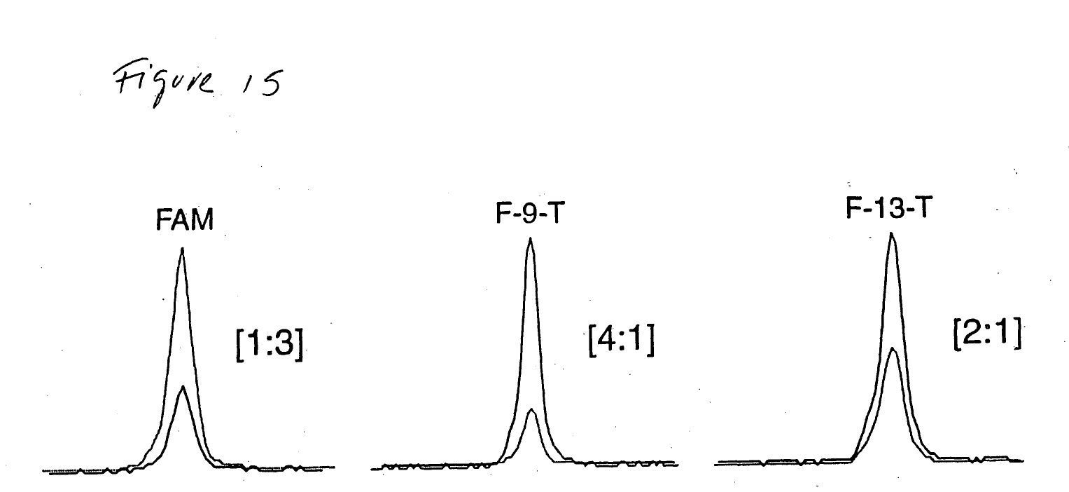

Schematic representation of the multiplex SNPs detection using CFET tags and biotinylated dideoxynucleotides is shown in FIG. 13. In this example, extension of the primers are initiated by ddCTP-Biotin (for primer 1) and ddGTP-Biotin (for primer 2) in the presence of DNA polymerase if there is a match between the 3′ end of the primer and the template (X and Y for primer 1; X′ and Y′ for primer 2). The extension products are isolated using streptavidin-coated magnetic beads. Upon denaturing, washing and releasing from the beads, the extension products are loaded onto an electrophoresis system and the resulting fluorescence signatures from the electropherogram identify each of the unique SNPs. Thus, the CFET-labeled oligonucleotides, DNA polymerase and biotinylated dideoxynucleotides form a high fidelity SNP detection system in which the base at the 3′ end of the oligonucleotides dictates its extension by incorporating a specific biotinylated dideoxynucleotide. The CFET tags used were F, -F-9-T and F-13-T. Their unique fluorescence signatures are shown in FIGS. 14 and 15

To increase the level of control over isolation, other isolation-permitting moieties such as phenylboronic acid, antigens or antibodies may be employed in place of the biotin. Attachment of the moieties via cleavable linker molecules enhances this still further.

VIII. High throughput Analyses.

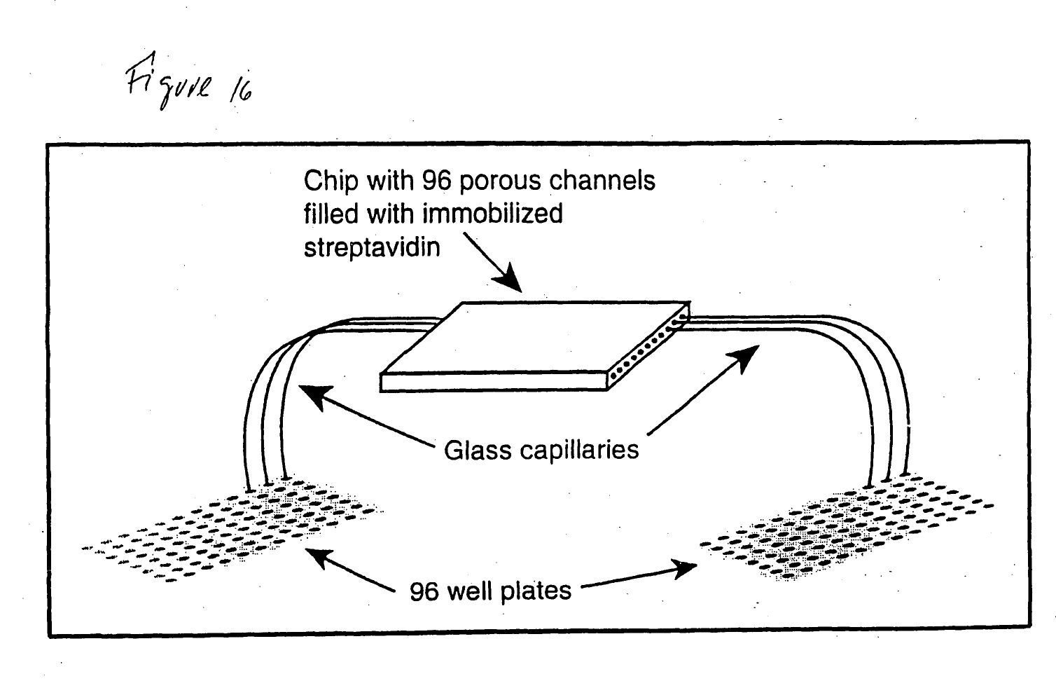

The throughput of the multiplex analyses offered by the use of the CFET tags can be increased by performing the analyses in the high throughput chamber illustrated in FIG. 16.

IX. In Combination with Non-FET Tags.

To increase the number of different unique fluorescent signatures available in any set of tags CFET tags can be used in combination with single chromophore/fluorophore tags and tags with multiple chromophores/fluorophores where no FET occurs. The number of possible different fluorescence signatures using such combinations is huge, and would greatly aid multiplex analyses. Such fluorophores could be quantum dots, luminescent molecules of fluorescent dyes. For example, each tag could be used to detect a different SNP using the exemplified assays.

### REFERENCES

U.S. Pat. No. 6,028,190 issued Feb. 222, 2000, Mathies et al.
Barany, F. (1991) Genetic disease detection and DNA amplification using cloned thermostable ligase. PNAS. 88:189-193.
Benson, S. C., Mathies, R. A. & Glazer, A. N. (1993).

Heterodimeric DNA-binding dyes designed for energy transfer: stability and applications of the DNA complexes. Nucleic Acids Res. 21: 5720-5726.
Benson, S. C., Singh, P. & Glazer, A. N. (1993). Heterodimeric DNA-binding dyes designed for energy transfer: synthesis and spectroscopic properties. Nucleic Acids Res. 21: 5727-5735.
Chee, M., Yang, R., Hubbell, E., Berno, A., Huang, X. C., Stern, D., Winkler, J., Lockhart, D. J., Morris, M. S., Fodor, S. P. (1996). Accessing genetic information with high-density DNA arrays. Science. 274:610-614.
Chen, X. and Kwok, PY. (1997) Template-directed dye-terminator incorporation (TDI) assay: a homogeneous DNA diagnostic method based on fluorescence resonance energy transfer Nucl. Acids. Res. 25: 347-353.
Eggerding F A (1995) A one-step coupled amplification and oligonucleotide ligation procedure for multiplex genetic typing. PCR Methods Appl. 4: 337-345.
Fischer, S. G., Cayanais, E., de Fatima Bonaldo, M., Bowcock, A. M., Deaven, L. L., Edelman, I. S., Gallardo, T., Kalachikov, S., Lawton, L., Longmire, J. L., Lovett, M., Osborne-Lawrence, S., Rothstein, R., Russo, J. J., Soares, M. B., Sunjevaric, I., Venkatraj, V. S., Warburton, D., Zhang, P. and Efstratiadis, A. (1996) A high-resolution annotated physical map of the human chromosome 13q12-13 region containing the breast cancer susceptibility locus BRCA2. Proc. Natl. Acad. Sci. U.S.A. 93: 690-694.
Forster, T. (1965) In: Modern Quantum Chemistry, Istanbul Lectures, Part III. Sinanoglu, O. (editor), Academic Press, New York, pp 93-137.
Glazer, A. N., Stryer, L. (1983) Fluorescent tandem phycobiliprotein conjugates. Emission wavelength shifting by energy transfer. Biophys. J. 43(3):383-386.
Hacia J. G., Edgemon K., Sun B., Stern D., Fodor S. A., Collins F. S. (1998). Two Color Hybridization Analysis Using High Density Oligonuleotide Arrays and Energy Transfer Dyes Nucleic Acids Research 15; 26: 3865-6
Ju, J., Glazer, A. N. & Mathies, R. A. (1996) Cassette labeling for facile construction of energy transfer fluorescent primers. Nucleic Acids Res. 24, 1144-1148.
Ju J, Glazer A N and Mathies R A (1996) Energy transfer primers: A new fluorescence labeling paradigm for DNA sequencing and analysis. Nature Medicine 2: 246-249.
Ju J, Ruan C, Fuller C W, Glazer A N and Mathies R A (1995) Energy transfer fluorescent dye-labeled primers for DNA sequencing and analysis. Proc. Natl. Acad. Sci. USA 92: 4347-4351.
Ju J, Yan H, Zaro M, Doctolero M, Goralski T, Konrad K, Lachenmeier E and Cathcart R (1997) DNA sequencing with solid phase captureable terminators. Microb. Comp. Genomics 2: 223.
Kalachikov, S. et al. (1997) Cloning and gene mapping of the chromosome. 13q14 region deleted in chronic lymphocytic leukemia. Genomics 42(3): 369-377.
Landegren U, Kaiser R, Sanders J and Hood L (1988) A ligase-mediated gene detection technique. Science 241: 1077-1080.
Lee L G, Spurgeon S L, Heiner C R, Benson S C, Rosenblum B B, Menchen S M, Graham R J, Constantinescu A, Upadhya K G and Cassel J M (1997) New energy transfer dyes for DNA sequencing. Nucleic Acids Res. 25: 2816-2822.
Lohmann D R (1999) RB1 gene mutations in retinoblastoma. Hum Mutat. 14: 283-288
Maxam A M and Gilbert W (1977) A new method for sequencing DNA. Proc Natl. Acad. Sci. USA 74: 560-564.
Munne S, Magli C, Bahce M, Fung J, Legator M, Morrison L, Cohert J. Gianaroli. (1998) Preimplantation diagnosis of the aneuploidies most commonly found in spontaneous abortions and live births: XY, 13, 14, 15, 16, 18, 21, 22. Prenat Diagn. 18: 1459-66.
Qu, X., Hauptschein, R. S., Rzhetsky, A., Scotto, L., Chien, M., Ye, X., Frigeri, F., Rao, P. H., Pasqualucci, L., Gamberi, B., Zhang, P., Chaganti, R. S. K., Dalla-Favera, R. and Russo, J. J. (1998) Analysis of a 69 kb contiguous genomic sequence at a putative tumor suppressor gene locus on human chromosome 6q27. DNA Seq. 9: 189-204.
Rosenblum, B. B., Lee, L. G., Spurgeon, S. L., Khan, S. H., Menchen, S. M., Heiner, C. R., Chen, S. M.(1997). New dye-labeled terminators for improved DNA sequencing patterns. Nucleic Acids Res 25: 4500-4
Rye, H. S., Drees, B. L., Nelson, H. C. M. & Glazer, A. N. (1993). Stable fluorescent dye-DNA complexes in high sensitivity detection of protein-DNA interactions. Application to heat shock transcription factor. J. Biol. Chem. 268: 25229-25238.
Sambrook et al., “Molecular Cloning: A Laboratory Manual”, Second Edition (1989), Cold Spring Harbor Laboratory Press, Cold Spring Harbor, N.Y.
Sanger F, Nickeln S and Coulson A R (1977) DNA sequencing with chain-terminating inhibitors. Proc. Natl. Acad. Sci. USA 74: 5463-5467.
Saxon E and Bertozzi C R (2000), Cell Surface Engineering by a Modified Staudinger Reaction. Science, 287: 2007-2010.
Schena, M., Shalon D., Davis, R. and Brown P. O. (1995) Quantitative monitoring of gene expression patterns with a CDNA microarray. Science 270:467-470.
Schrock E, du Manoir S, Veldman T, Schoell B, Wienberg J, Ferguson-Smith M A, Ning Y, Ledbetter D H, Bar-Am I, Soenksen D, Garini Yand Ried T (1996) Multicolor spectral karyotyping of human chromosomes. Science 273: 494-497.
Schubert E L, Hansen M F and Strong L C (1994). The retinoblastoma gene and its significance. Ann Med. 26: 177-184.
Smith, L. M., Sanders, J. Z., Kaiser, R. J., Hughes, P., Dodd, C., Connell, C. R., Heiner, C., Kent, S. B. H. and Hood, L. E. (1986). Fluorescence detection in automated DNA sequencing analysis. Nature. 321: 674-679.
Speicher M R, Ballard S G and Ward D C (1996) Karyotyping human chromosomes by combinatorial multi-fluor FISH. Nature Genet. 12: 368-375.
Stryer, L. (1978) Fluorescence energy transfer as a spectroscopic ruler. Annu. Rev. Biochem. 47: 819-846.
Tabor, S. & Richardson, C. C. A single residue in DNA polymerases of the Escherichia coli DNA polymerase I family is critical for distinguishing between deoxy-and dideoxyribonucleotides. 1995. Proc. Natl. Acad. Sci. U.S.A. 92: 6339-6343.
Uetz, et al; and S. Fields (2000) A comprehensive analysis of protein-protein interactions in Saccharomyces cerevisiae. Nature 403 (Number 6770) 623-627.
Vogel. (1989) Textbook Of Practical Organic Chemistry, Fifth Edition, Addison Wesley Longman, Harlow, U.K.
Wu D Y and Wallace R B (1989) The ligation amplification reaction (LAR): Amplification of specific DNA sequences using sequential rounds of template-dependent ligation. Genomics 4: 560-569.
Xu, G-L. wt al. (1999) Chromosome instability and immunodeficiency syndrome caused by mutations in a DNA methyltransferase gene. Nature 402: 187-191.
Zhu Z ; Chao J ; Yu H ; Waggoner A S (1994). Directly labeled DNA probes using fluorescent nucleotides with different length linkers. Nucleic Acids Res, 22: 3418-22.

What is claimed is:

1. A composition of matter comprising multiple fluorophores, each of which is bound to a molecular scaffold at a separate predetermined position on the scaffold, such separate predetermined positions being selected so as to permit fluorescence energy transfer between one such fluorophore and another such fluorophore, wherein the one such fluorophore and the another such fluorophore are characterized by the maximum emission wavelength of one being greater than the minimum excitation wavelength of the other.

2. A composition of matter of claim 1 comprising two fluorophores, each of which is bound to a molecular scaffold, at a separate predetermined position on the scaffold, such separate positions being selected so as to permit fluorescence energy transfer between such fluorophores, and such fluorophores being characterized by the maximum emission wavelength of one of the fluorophores being greater than the minimum excitation wavelength of the other fluorophore.

3. A composition of matter of claim 1 comprising three fluorophores each of which is bound to a molecular scaffold at a separate predetermined position on the scaffold, such separate predetermined positions being selected so as to permit fluorescence energy transfer among such fluorophores and such fluorophores being characterized by the maximum emission wavelength of one such fluorophore being greater than the minimum excitation wavelength of the second such fluorophore and the maximum emission wavelength of such second fluorophore being greater than the minimum excitation wavelength of the third such fluorophore.

4. The composition of matter of the claim 1, wherein each fluorophore is covalently bound to the molecular scaffold.

5. The composition of claim 1, wherein the efficiency of the fluorescence energy transfer is less than 20%.

6. The composition of claim 1, wherein the molecular scaffold is rigid.

7. The composition of claim 1, wherein the molecular scaffold is polymeric.

8. The composition of claim 9, wherein the molecular scaffold comprises a nucleic acid.

9. The composition of claim 9, wherein the molecular scaffold comprises a peptide.

10. The composition of claim 9, wherein the molecular scaffold comprises a polyphosphate.

11. The composition of claim 1, wherein at least one fluorophore is a fluorescent dye.

12. The composition of claim 11, wherein the fluorescent dye is 6-carboxyfluorescein.

13. The composition of claim 11, wherein the fluorescent dye is N,N,N′,N′-tetramethyl-6-carboxyrhodamine.

14. The composition of claim 11, wherein the fluorescent dye is cyanine-5 monofunctional dye.

15. The composition of claim 11, wherein at least one fluorophore is a luminescent molecule.

16. The composition of claim 11, wherein at least one fluorophore is a quantum dot.

17. A composition of matter having the structure: 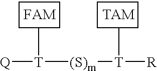
wherein S represents a 1′,2′-dideoxyribose phosphate moiety, m is an integer greater than 1 and less than 100, each T represents a thymidine derivative, FAM represents 6-carboxyfluorescein derivative, TAM represents N,N,N′,N′-tetramethyl-6-carboxyrhodamine derivative, each solid line represents a covalent bond, R represents either a hydroxy or phosphate terminus and Q represents either a hydroxy or phosphate terminus, with the proviso that R and Q are different.

18. The composition of claim 17, wherein m is 4.

19. The composition of claim 17, wherein m is 6.

20. The composition of claim 17, wherein m is 9.

21. The composition of claim 17, wherein m is 13.

22. A composition of matter having the structure: 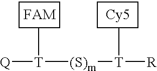
wherein S represents a 1′,2′-dideoxyribose phosphate moiety, m is an integer greater than 1 and less than 100, T represents a thymidine derivative, FAM represents a 6-carboxyfluorescein derivative, Cy5 represents a cyanine-5 monofunctional dye derivative, each solid line represents a covalent bond, R represents either a hydroxy or phosphate terminus and Q represents either a hydroxy or phosphate terminus, with the proviso that R and Q are different.

23. The composition of claim 22, wherein m is 4.

24. The composition of claim 22, wherein m is 5.

25. The composition of claim 22, wherein m is 7.

26. The composition of claim 22, wherein m is 10.

27. The composition of claim 22, wherein m is 13.

28. A composition of matter comprising the structure shown below: 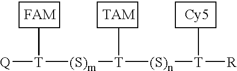
wherein S represents a 1′,2′-dideoxyribose phosphate moiety, m is an integer greater than 1 and less than 100, n is an integer greater than 1. and less than 100, T represents a thymidine derivative, FAM represents a 6-carboxyfluorescein derivative, Cy5 represents a cyanine-5 monofunctional dye derivative, TAM represents a N,N,N′,N′-tetramethyl-6-carboxyrhodamine derivative, each solid line represents a covalent bond, R represents either a hydroxy or phosphate terminus and Q represents either a hydroxy or phosphate terminus, with the proviso that R and Q are different.

29. The composition of claim 28, wherein m is 3, and n is 7.

30. The composition of claim 28, wherein m is 4, and n is 6.

31. The composition of claim 28, wherein m is 5, and n is 5

32. The composition of claim 28, wherein m is 6, and n is 6.

33. The composition of claim 28, wherein m is 7, and n is 7.

34. A composition of matter comprising the structure shown below: 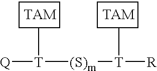
wherein S represents a 1′,2′-dideoxyribose phosphate moiety, m represents an integer greater than 1 and less than 100, T represents a thymidine derivative, and TAM represents a N,N,N′,N′-tetramethyl-6-carboxyrhodamine derivative, each solid line represents a covalent bond, R represents either a hydroxy or phosphate terminus and Q represents either a hydroxy or phosphate terminus, with the proviso that R and Q are different.

35. The composition of claim 34, wherein m is 4.

36. A nucleic acid labeled with the composition of any of claims 1, 17, 22, 28 and 34.

37. The nucleic acid of claim 36, wherein the nucleic acid is DNA.

38. The nucleic acid of claim 36, wherein the nucleic acid is RNA.

39. The nucleic acid of claim 36, wherein the nucleic acid is DNA/RNA.

40. A method of determining whether a preselected nucleotide residue is present at a predetermined position within a nucleic acid comprising the steps of:
contacting the nucleic acid, under hybridizing and DNA ligation-permitting conditions, with (i) a DNA ligase, (ii) a first oligonucleotide having affixed thereto a composition of matter of claim 1 wherein the first oligonucleotide hybridizes with nucleotides immediately adjacent one side of the predetermined position and (iii) a second oligonucleotide which hybridizes with the nucleotides immediately adjacent the other side of the predetermined position, wherein the hydroxy-terminal residue of the oligonucleotide which hybridizes to the nucleotide located 3′ of the predetermined position is a nucleotide which is complementary to the preselected nucleotide residue; and
(b) detecting the presence of a ligation product comprising both the first and the second oligonucleotides, the presence of such a ligation product indicating the presence of the preselected nucleotide residue at the predetermined position.

41. A method of determining whether at various predetermined positions within a nucleic acid, a preselected nucleotide residue is present at such position, wherein the preselected nucleotide residue may vary at different predetermined positions which comprises determining whether each preselected nucleotide is present each predetermined position according to the method of claim 42.

42. The method of claim 41, wherein the presence of a plurality of given nucleotide residues is determined simultaneously.

43. The method of claim 40, wherein the DNA ligase is Taq DNA ligase.

44. The method of claim 40, wherein the second oligonucleotide has an isolation-permitting moiety affixed thereto, and wherein the method further comprises the steps of isolating the moiety-containing molecules resulting from step (a) and determining the presence therein of ligated first and second oligonucleotides.

45. The method of claim 40, wherein the composition of matter affixed to the first oligonucleotide has a predetermined emission spectrum, and wherein the observation of this emission spectrum is employed to determine the presence of ligated first and second oligonucleotides in step (b).

46. A method of determining whether a preselected nucleotide residue is present at a predetermined position within a nucleic acid comprising the steps of:
(a) contacting the nucleic acid, under hybridizing and DNA polymerization-permitting conditions, with (i) a DNA polymerase, (ii) an oligonucleotide (1) having affixed thereto a composition of matter of claim 1, and (2) having a hydroxyl 3′ terminus thereof, wherein the oligonucleotide hybridizes with the 3′ region of the nucleic acid molecule flanking the predetermined position, and (iii) a dideoxynucleotide labeled with an isolation-permitting moiety, wherein the labeled dideoxynucleotide is complementary to the given nucleotide residue,
with the proviso that upon hybridization of the oligonucleotide with the nucleic acid in the presence of DNA polymerase and the preselected nucleotide residue, the oligonucleotide and dideoxynucleotide are juxtaposed so as to permit their covalent linkage by the DNA polymerase;
(b) detecting the presence of a polymerization product comprising both the oligonucleotide and the dideoxynucleotide, the presence of such a polymerization product indicating the presence of the preselected nucleotide residue at the predetermined position.

47. A method of determining whether at various predetermined positions within a nucleic acid, a preselected nucleotide residue is present at such position, wherein the preselected nucleotide residue may vary at different predetermined positions which comprises determining whether each preselected nucleotide is present each predetermined position according to the method of claim 46.

48. The method of claim 46, wherein the DNA polymerase is thermo sequenase.

49. The method of claim 46, wherein the dideoxynucleotide is selected from the group consisting of dideoxyadenosine triphosphate, dideoxycytidine triphosphate, dideoxyguanosine triphosphate, dideoxythymidine triphosphate, and dideoxyuridine triphosphate.

50. The method of claim 46, wherein the composition of matter affixed to the oligonucleotide has a predetermined emission spectrum, and wherein the observation of this emission spectrum is employed to determine the presence of polymerization product in step (b).

51. The method of claim 45 or 50, wherein observing the predetermined emission spectrum is performed using radiation having a wavelength of between 200 and 1000 nm.

52. The method of claim 51, wherein the radiation has a wavelength of 488 nm.

53. The method of claim 45 or 50 wherein observing the predetermined emission spectrum is performed using radiation having a bandwidth of between 1 and 50 nm.

54. The method of claim 53, wherein the radiation bandwidth is 1 nm.

55. The method of claim 44 or 46, wherein the isolation-permitting moiety comprises biotin, streptavidin, phenylboronic acid, salicylhydroxamic acid, an antibody or an antigen.

56. The method of claim 55, wherein the isolation-permitting moiety is attached to the oligonucleotide via a linker molecule.

57. The method of claim 46, wherein the isolation-permitting moiety is attached to the dideoxynucleotide via a linker molecule.

58. The method of claim 56 or 57, wherein the linker molecule is chemically cleavable.

59. The method of claim 56 or 57, wherein the linker molecule is photocleavable.

60. The method of claim 59, wherein the linker molecule has the structure: [chemical structure]


SEQUENCE LISTING (17 sequences)

SEQ ID NO: 1 - DNA, 26 bp, Artificial Sequence
  ARTIFICIAL SCAFFOLD FOR STRUCTURAL PURPOSES
tttttttttttttttttttttttttc

SEQ ID NO: 2 - DNA, 20 bp, Artificial Sequence
  PRIMER DIRECTED TO RB1 GENE
ttaaaaagaataagggtgtc

SEQ ID NO: 3 - DNA, 20 bp, Artificial Sequence
  PRIMER DIRECTED TO RB1 GENE
acatagccgatcggatagag

SEQ ID NO: 4 - DNA, 22 bp, Artificial Sequence
  PRIMER DIRECTED TO RB1 GENE
tcatagccgatcggatagaggc

SEQ ID NO: 5 - DNA, 20 bp, Artificial Sequence
  PRIMER DIRECTED TO RB1 GENE
acatagccgatcggatagag

SEQ ID NO: 6 - DNA, 24 bp, Artificial Sequence
  PRIMER DIRECTED TO RB1 GENE
gccgatttatgtgaaacacttgcg

SEQ ID NO: 7 - DNA, 26 bp, Artificial Sequence
  PRIMER DIRECTED TO RB1 GENE
accgatttatgtgaaacacttgcgga

SEQ ID NO: 8 - DNA, 20 bp, Artificial Sequence
  PRIMER DIRECTED TO RB1 GENE
cggaagacagactcgtgggt

SEQ ID NO: 9 - DNA, 28 bp, Artificial Sequence
  PRIMER DIRECTED TO RB1 GENE
cttaatcttgtatagtagacctgggaaa

SEQ ID NO: 10 - DNA, 30 bp, Artificial Sequence
  PRIMER DIRECTED TO RB1 GENE
attaatcttgtatagtagacctgggaaaag

SEQ ID NO: 11 - DNA, 20 bp, Artificial Sequence
  PRIMER DIRECTED TO RB1 GENE
atagtagacctgggaaaagg

SEQ ID NO: 12 - DNA, 30 bp, Artificial Sequence
  PRIMER DIRECTED TO RB1 GENE
tcgtgtgggacgtcttactcatacttgagt

SEQ ID NO: 13 - DNA, 32 bp, Artificial Sequence
  PRIMER DIRECTED TO RB1 GENE
gcgtgtgggacgtcttactcatacttgagtac

SEQ ID NO: 14 - DNA, 100 bp, Artificial Sequence
  SYNTHETIC TEMPLATE, NO SOURCE
gtaaaaatgactaatttttcttattcccacagtgtatcggctagcctatctccggctaaatacactttgtgaacgccttctgtctgagcacccagaatta

SEQ ID NO: 15 - DNA, 100 bp, Artificial Sequence
  SYNTHETIC TEMPLATE, NO SOURCE
gtaaaaatgactaatttttcttattcccacagagtatcggctagcctatctctggctaaatacactttgtgaacgccttctgtctgagcacccagaatta

SEQ ID NO: 16 - DNA, 100 bp, Artificial Sequence
  SYNTHETIC TEMPLATE, NO SOURCE
tacactttgtgaacgccttctgtctgagcacccagaattagaacatatcatctggacccttttccagcacaccctgcagaatgagtatgaactcatgaga

SEQ ID NO: 17 - DNA, 100 bp, Artificial Sequence
  SYNTHETIC TEMPLATE, NO SOURCE
tacactttgtgaacgccttctgtctgagcacccataattagaacatatcatctggacccttttcccgcacaccctgcagaatgagtatgaactcatgaga